(19) United States
(12) Patent Application Publication
(10) Pub. No.: US 2010/0315402 A1
(43) Pub. Date: Dec. 16, 2010

(54) Display panel driving method, gate driver, and display apparatus

(75) Inventor: Yoshiharu Hashimoto, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/662,806

(22) Filed: May 4, 2010

(30) Foreign Application Priority Data
Jun. 12, 2009 (JP) 2009-141378
Mar. 29, 2010 (JP) 2010-075862

(51) Int. Cl. G06F 3/038

(52) U.S. Cl. 345/211

(57) ABSTRACT

A method of driving a display panel in which a voltage polarity reverse cycle of a data signal is three or more scan periods, and multiple scan lines are driven by switching between a first and a second scan orders by a predetermined period. The method includes setting a display pattern as a first maximum current pattern, the display pattern in which the multiple scan lines are driven in the first scan order and a number of charge and discharge of the data signal becomes a maximum number, and specifying that the number of charge and discharge of the data signal when displaying the first maximum current pattern in the second scan order is to be ½ of that of the data signal when displaying the first maximum current pattern in the first scan order. Further, the voltage polarity reverse cycle for specifying the first and the second scan orders is one frame period.

### INCORPORATION BY REFERENCE

This application is based upon and claims the benefit of priority from Japanese patent application No. 2009-141378, filed on Jun. 12, 2009, and Japanese patent application No. 2010-75862, filed on Mar. 29, 2010, the disclosures of which are incorporated herein in their entirety by reference.

### BACKGROUND

1. Field of the Invention

The present invention relates to display panel driving method, a gate driver, and a display apparatus, and particularly to a display panel driving method that switches multiple scan orders by a predetermined period to drive, a gate driver, and a display apparatus.

2. Description of Related Art

A matrix liquid crystal display panel including liquid crystal cells arranged in a matrix is one of the most typical display devices. Liquid crystal cells, scan lines for selecting rows of the liquid crystal cells, and data lines for supplying data signals are provided in a liquid crystal display panel. The scan line and the data line are placed in a grid pattern. A liquid crystal cell is placed to each intersection where the scan line and the data line cross each other.

A liquid crystal cell is provided with a pixel electrode and a TFT (Thin film transistor). A common electrode is provided in a position to oppose the pixel electrode. A liquid crystal is filled between the pixel electrode and the common electrode. To drive a liquid crystal display panel, the polarity of a data signal supplied to a pixel electrode is reversed for every predetermined period, in order to suppress the deterioration of the liquid crystal material. This inversion driving scheme includes dot inversion driving, column inversion driving, line inversion driving, and frame inversion driving, for example.

Among the dot inversion driving, in 1H dot inversion (1×1 dot inversion) driving, the voltage of the common electrode is fixed, the voltage polarities of adjacent data lines are different, and the voltage polarity of the data signal is reversed for every scan period. The 1H dot inversion driving achieves the best image quality of the four driving methods. One of the reason for this is that in the 1H dot inversion driving, as all data lines are precharged to a predetermined medium voltage at the beginning of one scan period or all data lines are shorted (also called as charge sharing), thus there is no influence from the previous data signal. However, if a liquid crystal panel is normally black, the driving current becomes the largest in the white raster pattern with high appearance frequency.

In the column inversion driving, the voltage of the common electrode is fixed, the voltage polarities of adjacent data lines are different, and the voltage polarity of the data signal is reversed for every frame period. In 2H dot inversion (2×1 dot inversion) driving, a common electrode is fixed, the voltage of the common electrode is fixed, the voltage polarity of adjacent data lines are different, and the voltage polarity of the data signal is reversed for every two scan periods. In any of the driving method, the driving current becomes the largest in the horizontal stripe pattern or check pattern in which the voltage level of a data signal changes by each scan period. The driving current at the time of this display pattern is reduced by ½ of the maximum driving current in the 1H dot inversion driving.

Low response speed of the liquid crystals causes to generate motion blur. In a liquid crystal display panel for television use, the motion blur is improved by generating an interpolated frame between supplied frames, and performing double-speed drive (120 Hz). However, if 1H dot inversion driving is performed in the double-speed drive, the driving current increases and the amount of heat generated in the data driver increases, thereby increasing the temperature too high and possibly leading to destroy the data driver.

By the way, in Japanese Unexamined Patent Application Publication No. 7-64512 (Okumura), image data in one frame period is monitored and the scan orders are specified so that the number of charge and discharge of data signals becomes the minimum number so as to reduce the power consumption.

### SUMMARY

However, the present inventor has found a problem that the maximum driving current in the column inversion driving is only ½ of the maximum driving current of the 1H dot inversion driving, and the driving current per unit time is twice the driving current in the normal driving. This causes the data driver to be high temperature. Although the data driver does not result in destruction, if the data driver becomes high temperature, the driving capability is reduced and thereby reducing the image quality.

Further, in the method disclosed by Okumura that image data in one frame period is monitored to specify the scan order, the circuit size for monitoring the image data increases along with the increase in the number of pixels. Further, the circuit of the gate driver is also complicated, for example requiring eight bits decoder in 256 outputs and 10 bits decoder in 1024 outputs, thus increasing the circuit size.

An exemplary aspect of the present invention is a method of driving a display panel in which a voltage polarity reverse cycle of a data signal is three or more scan periods, and multiple scan lines are driven by switching between a first and a second scan orders by a predetermined period. The method includes setting a display pattern as a first maximum current pattern, the display pattern in which the multiple scan lines are driven in the first scan order and a number of charge and discharge of the data signal becomes a maximum number, and specifying that the number of charge and discharge of the data signal in case of displaying the first maximum current pattern in the second scan order is to be ½ of the number of charge and discharge of the data signal in case of displaying the first maximum current pattern in the first scan order. Further, the voltage polarity reverse cycle for specifying the first and the second orders is one frame period. Then by switching at least two or more scan orders having different maximum current patterns by a predetermined period, the average driving current of the data signals in a particular display pattern can be reduced, and thereby reducing the highest attainable temperature of the data driver.

The driving method of the present invention enables to reduce the average driving current of data signals in a particular display pattern and reduce the highest attainable temperature of data driver without monitoring image data and also increasing the circuit size of the gate driver.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a block diagram illustrating the configuration of a display apparatus according to an exemplary embodiment;

FIG. 2 explains a driving method of a display panel according to a first exemplary embodiment;

FIG. 3 is a timing chart for explaining the driving method of the display panel according to the first exemplary embodiment;

FIG. 4 illustrates a typical display pattern;

FIG. 5 is a table illustrating a voltage level and a driving current of data signals in the display apparatus according to the first exemplary embodiment;

FIG. 6 explains a driving method of a display panel according to a second exemplary embodiment;

FIG. 7 is a timing chart for explaining the driving method of the display panel according to the second exemplary embodiment;

FIG. 8 is a table illustrating a voltage level and a driving current of data signals in the display device according to the second exemplary embodiment;

FIG. 9 explains a driving method of a display panel according to a third exemplary embodiment;

FIG. 10 explains a driving method of a display panel according to a fourth exemplary embodiment;

FIG. 11 illustrates an arrangement example of liquid crystal cells in a display panel for explaining a driving method of a display panel according to a fifth exemplary embodiment;

FIG. 12 is a plan view illustrating a layout near scan lines of the display panel of FIG. 11;

FIG. 13 is a cross-sectional diagram taken along the line XIII-XIII of FIG. 12;

FIG. 14 illustrates an arrangement example of liquid crystal cells in a display panel for explaining a driving method of a display panel according to the fifth exemplary embodiment;

FIG. 15 is a plan view illustrating a layout near scan lines of the display panel of FIG. 14;

FIG. 16 is a cross-sectional diagram taken along the line XVI-XVI of FIG. 15;

FIG. 17 illustrates an arrangement example of liquid crystal cells in a display panel;

FIG. 18 illustrates an arrangement example of liquid crystal cells if the total number of data lines is doubled;

FIG. 19 illustrates an arrangement example of liquid crystal cells if the total number of data lines is doubled;

FIG. 20 illustrates an arrangement example in case one pixel is composed of four liquid crystal cells;

FIG. 21 is a plan view illustrating a layout in case one pixel is composed of four liquid crystal cells;

FIG. 23 is a plan view illustrating a layout in case one pixel is composed of four liquid crystal cells;

FIG. 23 illustrates the configuration of a gate driver used by an exemplary embodiment;

FIG. 24 illustrates the configuration of a gate driver used by an exemplary embodiment;

FIG. 25 illustrates COF of a gate driver or lines over a display panel used by an exemplary embodiment;

FIG. 26 illustrates the configuration of a gate driver used by an exemplary embodiment;

FIG. 27 is a timing chart which realizes the driving method of a display panel according to the first exemplary embodiment using the gate driver illustrated in FIG. 23;

FIG. 28 is a timing chart which realizes the driving method of a display panel according to the second exemplary embodiment using the gate driver illustrated in FIG. 23;

FIG. 29 is a timing chart for explaining the driving method of a display panel according to the fifth exemplary embodiment;

FIG. 30 is a timing chart for explaining the driving method of a display panel according to the fifth exemplary embodiment; and

FIG. 31 is a timing chart for explaining the driving method of a display panel according to a sixth exemplary embodiment.

### DETAILED DESCRIPTION OF THE EXEMPLARY EMBODIMENTS

### First Exemplary Embodiment

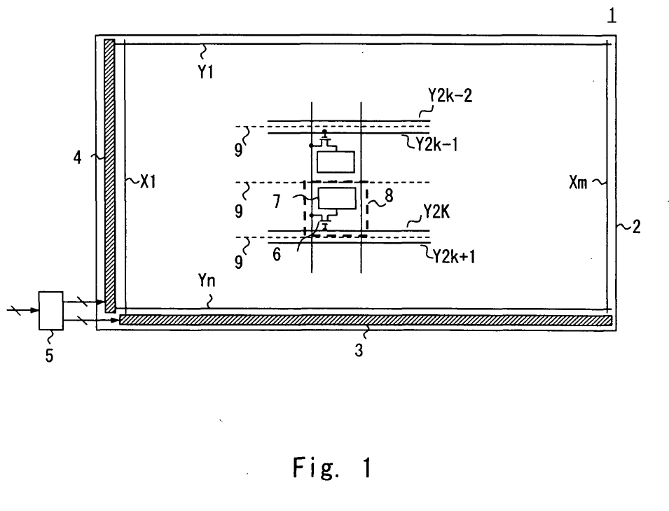

The configuration of a display device according to a first exemplary embodiment of the present invention is explained with reference to FIG. 1. FIG. 1 is a block diagram illustrating the configuration of a liquid crystal display 1 according to this exemplary embodiment. As illustrated in FIG. 1, the liquid crystal display 1 is provided with a liquid crystal display panel 2, a data driver 3, a gate driver 4, and a timing controller 5. Although not illustrated in the drawing, the liquid crystal display 1 is provided with a backlight that illuminates the display from the back of the liquid crystal display panel 2, and a power supply that supplies power supply voltage to the data driver 3 and the gate driver 4, for example.

Multiple data lines X1 to Xm extending in the column (vertical) direction, and multiple scan lines Y1 to Yn extending in the row (horizontal) direction are formed in a grid pattern. A liquid crystal cell 8 which functions as a display cell is formed in the intersection of the data line and the scan line.

The liquid crystal cell 8 is provided with a TFT (Thin Film Transistor) 6, which functions as a switching element, and a pixel electrode 7. In each liquid crystal cell 8, a liquid crystal is filled between the pixel electrode 7 and an opposing common electrode. A gate electrode of the TFT 6 is connected respectively to the scan lines Y1 to Yn, a source electrode is connected respectively to the data lines X1 to Xm, and a drain electrode is connected respectively to the pixel electrode 7. A fixed voltage (Vcom) is supplied to the common electrode. Further, each liquid crystal cell 8 is covered with one color filter among the three colors, red (R), green (G), and blue (B). One pixel is composed of three RGB liquid crystal cells 8.

A parasitic capacitance exists between the pixel electrode 7 and the pixel electrode 7 of another row. Therefore, the potential of the pixel electrode 7 already written with data signals may be fluctuated by a potential fluctuation of the pixel electrode 7 yet to be written with data signals of another row. The potential fluctuation resulting from this parasitic capacitance is hereinafter referred to as coupling noise. In order to reduce this coupling noise, an auxiliary capacitance line 9 horizontally extending in the horizontal direction in the same layer as the pixel electrode 7 is provided between the pixel electrode 7 and the pixel electrode 7 of another row. The auxiliary capacitance line 9 has two functions as an auxiliary capacitance and a shield. A fixed voltage having a value equal or substantially equal to Vcom is provided to the auxiliary capacitance line 9.

Generally, there are a positive and negative polarities for the voltage polarity (may only be referred to as a polarity) of the data signal in the liquid crystal display. Further, there are bright and dark in the voltage level (gray scale) of the data signal. If the voltage level is 256 shades, four data signals, which are; a data signal V255p with positive polarity and bright (maximum luminance) of a voltage level, a data signal V255n with negative polarity and bright (maximum luminance) voltage level, a data signal V0p with positive polarity and dark (minimum luminance) voltage level, a data signal V0n with negative polarity and dark (minimum luminance) voltage level, have different voltage value from each other.

Suppose that the liquid crystal display panel 2 is normally black in this example. Therefore, if the data signal has the voltage V0p or V0n, which is near Vcom, the display on the liquid crystal display panel 2 becomes dark, whereas if the data signal has the voltage V255p or V255n, which is far from Vcom, the display becomes bright.

The timing controller 5 generates and supplies signals necessary for driving the data driver 3 and the gate driver 4 from a vertical synchronization signal Vsync, a horizontal synchronization signal Hsync, a dot clock dCLK, and image data DR, DG, and DB, for example, which are supplied to the timing controller 5. Note that interpolated frames in the double-speed drive are generated in the image signal processing unit (not illustrated), which is provided in a previous stage of the timing controller 5.

The data driver 3 supplies data signals to the data lines X1 to Xm. This exemplary embodiment adopts what is called column inversion driving. Accordingly, the voltage polarities of adjacent data lines are different, and the voltage polarities of the data signals are reversed by each frame period. Therefore, the voltage polarity of each liquid crystal cell 8 is reversed for every frame period. Note that in the liquid crystal cell 8 far from the data driver 3, the writing rate may be reduced due to waveform rounding. If the writing rate for the pixel electrode 7 is reduced due to waveform rounding, it is preferable to drive one data line X from two positions, which are top and bottom of the liquid crystal display panel 2, at the same time. The data driver 3 is required for high-speed operation and high voltage accuracy, thus the data driver 3 is fabricated by forming a circuit over a semiconductor substrate such as silicon.

The data lines X1 to Xm and the liquid crystal cells 8 of the liquid crystal display panel 2 are capacitive load, and a current does not flow while the voltage is stable. The voltage polarity of each liquid crystal cell 8 is reversed for every frame period as mentioned above. However, the parasitic capacitance of the data lines X1 to Xm is several hundreds pF (picofarad), whereas the capacitance of the liquid crystal cell 8 is several hundreds fF (femtofarad). Therefore, the charge and discharge current of the liquid crystal cell 8 is about 1/1000 of the driving current of the data signal, which is almost negligible. Accordingly, in the column inversion driving, if the voltage level of the data signal does not change, it can be considered that the no driving current flows.

The gate driver 4 supplies scanning signals (Vgon and Vgoff) to the scan lines Y1 to Yn. In the vertical blanking period, the voltage Vgoff to turn off the TFT 6 is supplied to all the scan lines Y1 to Yn. Supplying the voltage Vgon which turns on the TFT 6 to the corresponding scan line Y only in a predetermined period is referred to as driving (or selecting) the scan line Y. Note that in order to reduce the waveform rounding of the scan signal, it is preferable to mount the gate driver 4 to the left and right positions of the liquid crystal display panel 2, and drive one scan line from the left and right positions at the same time. In order to form the gate driver 4, a circuit may be formed in a semiconductor substrate, however the operating speed and output voltage accuracy of the gate driver 4 is not as high as the data driver 3, thus a circuit may be formed over the liquid crystal display panel 2.

A color liquid crystal display panel which includes the number of pixels corresponding to full HD (1920×1080 pixels) is explained here. In the full HD color liquid crystal display panel, there are 5760 data lines and 1080 scan lines. This exemplary embodiment explains continuous two scan lines Y2k−1 and Y2k (k is a natural number) as the kth scan group (may be referred to as kGrth in the drawings). The scan lines Y1 and Y2 are the first scan group, the scan lines Y3 and Y4 are the second scan group, the scan lines Y5 and Y6 are the third scan group, the scan lines Y7 and Y8 are the fourth scan group, the scan lines Y9 and Y10 are the fifth scan group, . . . and the scan lines Y1079 and Y1080 are the 540th scan group.

Eight continuous scan lines are explained as one scan block. The scan lines Y1 to Y8 are the first scan block, the scan lines Y9 to Y16 are the second scan block, . . . and the scan lines Y1073 to Y1080 are the 135th scan block. The scan order of the first scan block is mainly explained hereinafter. The scan blocks other than the first scan block are driven in the similar scan order of the first scan block.

In the following explanation, the liquid crystal cell 8 connected to the scan line Y1 may be referred to as a liquid crystal cell “1”, the liquid crystal cell 8 connected to the scan line Y2 may be referred to as a liquid crystal cell “2”, and the liquid crystal cell 8 connected to the scan line Yn may be referred to as a liquid crystal cell “n”. From relative physical relationship, the liquid crystal cell 8 connected to the scan line Y2k−1 which belongs to the kth scan group may be referred to as a liquid crystal cell “2k−1”, the liquid crystal cell 8 connected to the scan line Y2k may be referred to as a liquid crystal cell “2k”, the liquid crystal cell 8 connected to the scan line Y2k−3 which belongs to the previous scan group may be referred to as a liquid crystal cell “2k−3”, and the liquid crystal cell 8 connected to the scan line Y2k−2 may be referred to as a liquid crystal cell “2k−2”.

The scan groups in one frame period are driven in the scan order of first scan group second scan group→third scan group→fourth scan group→fifth scan group→ . . . 540th scan group. Then, in the scan order in the scan group, the scan order in which odd numbered scan lines Y2k−1 are driven first and even numbered scan lines Y2k are driven later is referred to as forward scan, whereas the scan order in which even numbered scan lines Y2k are driven first and odd numbered scan lines Y2k−1 are driven later is referred to as backward scan.

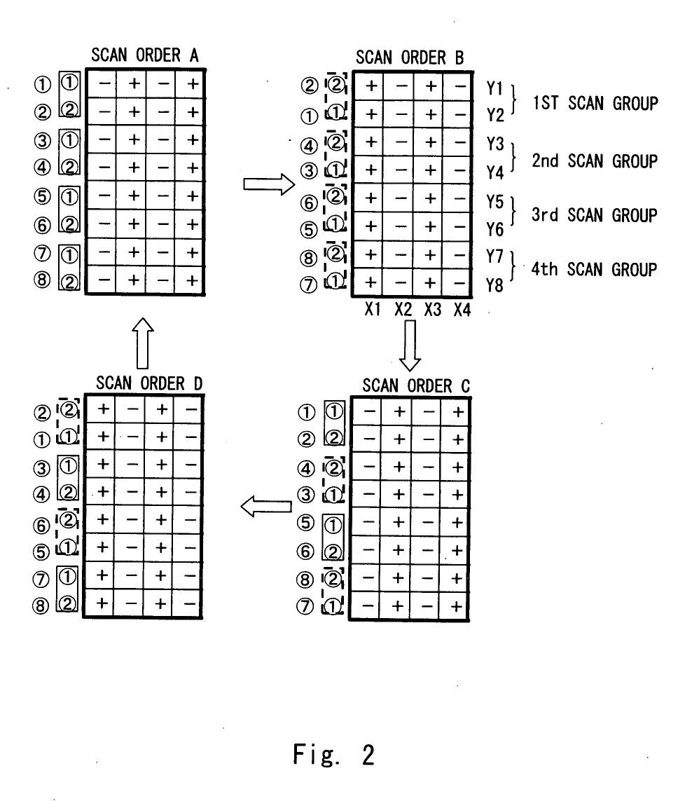

FIG. 2 illustrates the scan order of each scan line in one scan block according to this exemplary embodiment. The numbers 1 and 2 surrounded by the solid line indicate that the corresponding scan groups are forward scan, and the numbers 2 and 1 surrounded by the dotted line indicate that the scan groups are backward scan. In the scan group, 1 indicates that the corresponding scan line is driven first, and 2 indicates that the corresponding scan line is driven after 1. In the scan order A, as with the scan order of a related art, each scan group is scanned in the forward scan. That is, from the first scan period to the eighth scan period, the scan lines are driven in the order of Y1→Y2→Y3→Y4→Y5→Y6→Y7→Y8. In the scan order B, each scan group is scanned in the backward scan. That is, from the first scan period to the eighth scan period, the scan lines are driven in the order of Y2→Y1→Y4→Y3→Y6→Y5→Y8→Y7.

In the scan order C, the first and third scan groups are the forward scan, and the second and the fourth scan groups are backward scan. That is, the scan lines are driven in the order of Y1→Y2→Y4→Y3→Y5→Y6→Y8→Y7. In a scan order D, the first and third scan groups are the backward scan, and the second and fourth scan groups are the forward scan. That is, the scan lines are driven in the order of Y2→Y1→Y3→Y4→Y6→Y5→Y7→Y8.

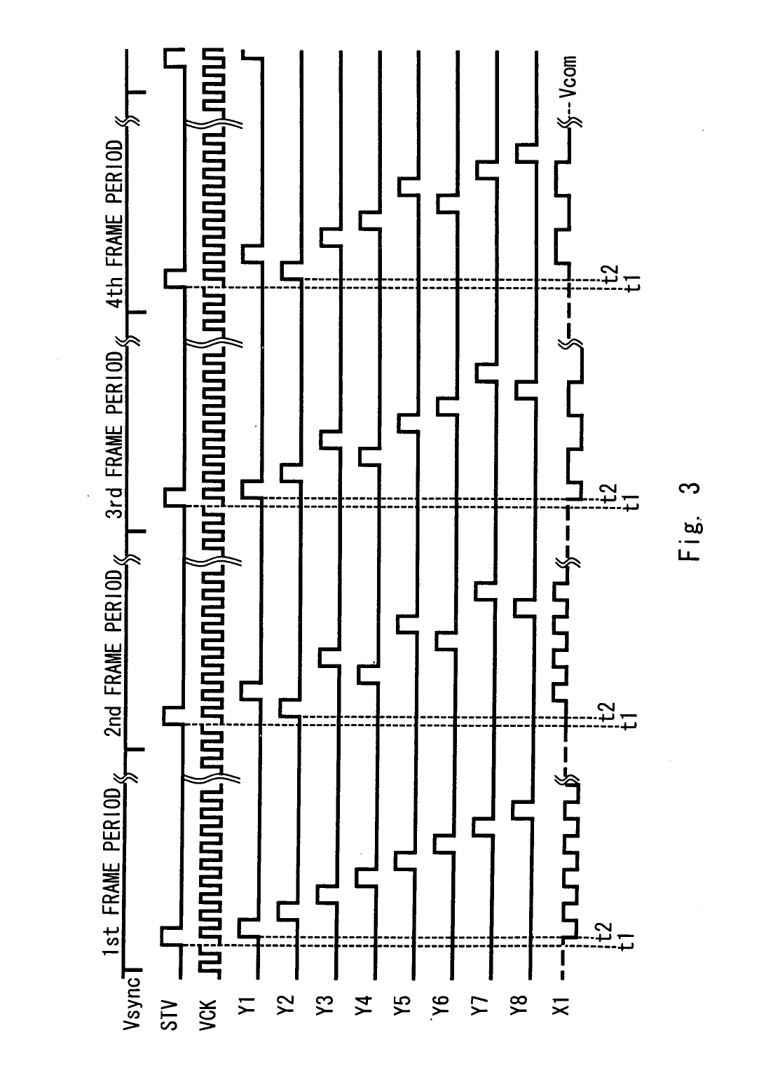

Next, the driving method according to this exemplary embodiment is explained with reference to FIG. 3. FIG. 3 is a timing chart for explaining the driving method of the display panel according to this exemplary embodiment. In FIG. 3, only the scan order of the first scan block is depicted. The scan order of other scan blocks are same as the first scan block, thus the explanation is omitted.

As illustrated in FIG. 3, if the vertical synchronization signal Vsync is input to the timing controller 5, a vertical start signal STV is input to the gate driver 4 at the time t1 of each frame period, and then a first scan is started in each frame period at the following time T2.

In the first frame period, eight scan lines in each scan block are driven in the scan order A explained in FIG. 2. In the second frame period following the first frame period, eight scan lines in each scan block are driven in the scan order B. In the third frame period following the second frame period, eight scan lines in each scan block are driven in the scan order C. In the fourth frame period following the third frame period, eight scan lines in each scan block are driven in the scan order D.

Next, the order between the scan orders A, B, C, and D is explained. When driving in the order of scan order A→ scan order B→ scan order C→ scan order D, and returning back to the scan order A again to circulate, this is described as frame order A→B→C→D.

There are six ways in this frame order. They are; frame order A→B→C→D, frame order A→B→D→C, frame order A→C→D→B, frame order A→D→C→B, frame order A→C→B→D, and frame order A→D→B→C. It may be any of the frame orders. As the frame orders are circulated, the frame order B→C→D→A is considered to be the same as the frame order A→B→C→D.

Since the positive polarity gamma curve and the negative electrode gamma curve are asymmetrical, the image quality is reduced in case of incorrect configuration of gray scale voltage. Therefore, it is preferable to switch the scan order by each two frames, so that each of the positive and negative polarities of a data signal is driven in one scan order. If the scan orders A, B, C, and D are switched by each two frames, the scan orders circulate in eight frame periods. As an example to switch the scan orders by every two frame periods, the scan order A (negative)→scan order A (positive)→scan order C (negative)→scan order C (positive)→scan order B (negative)→scan order B (positive)→scan order D (negative)→scan order D (positive). The positive and negative enclosed in the parentheses indicates the voltage polarities of one frame period supplied to the data line X1.

As another examples to circulate the scan orders once in eight frame periods, the scan order may be switched by each frame period such as, the scan order A (negative)→scan order C (positive)→scan order B (negative)→scan order D (positive) scan order C (negative) scan order A (positive)→scan order D (negative)→scan order B (positive). The average driving current of data signals in eight frame periods is the same as that of data signals in four frame periods.

In the timing chart of FIG. 3, X1 at the bottom indicates a voltage level of a data signal supplied to the data line X1 when displaying a display pattern 1, which is described later. As illustrated in FIG. 3, in the first and third frame periods, a negative polarity voltage (V0n or V255n) is supplied. In the second and fourth frame periods, a positive polarity voltage of V0p or V255p is supplied. In the following explanation, the voltage level of a data signal in the ninth scan period is enclosed by parentheses in order to clarify the change in the voltage level of the data signal in the eighth and ninth scan periods (the first scan period in the second scan block).

In the first frame period, the data signals are supplied in the first to eighth scan periods in the following order, in which the voltage of the data signals are bright→dark→bright→dark→bright→dark→bright→dark (→bright). Thus, an order that starts with bright and the number of charge and discharge is eight is referred to as a data signal order A. In the second frame period, the data signals are supplied in the following order, in which the voltage of the data signals are dark→bright→dark→bright→dark→bright→dark→bright (→dark). Thus, an order that starts with dark and the number of charge and discharge is eight is referred to as a data signal order B.

Therefore, in the data signal orders A and B, the voltage level of the data signal changes eight times in eight scan periods, thereby making the driving current of the data signal maximum. The driving current of the data signal at this time shall be 1, which is hereinafter referred to as a reference current value. Further, the display pattern in which the driving current of the data signals becomes the maximum current is referred to as a maximum current pattern.

In the third frame period, the data signals are supplied in the following order, in which the voltage of the data signals are bright→dark →dark→bright→bright→dark→dark→bright (→bright). The number of charge and discharge of the data signals is reduced by half as compared to the first and second frame periods, and the driving current is ½ (0.5) of the reference current value. As the voltage polarity of the data signal is reversed between frames, the driving current is slightly larger than ½ of the reference current to be exact.

In the fourth frame period, the data signals are supplied in the following order, in which the voltage of the data signals are dark→bright→bright→dark→dark→bright→bright→dark (→dark). The number of charge and discharge of the data signals is reduced by half as compared to the first and second frame periods, and the driving current is ½ (0.5) of the reference current value. Therefore, the average driving current of the four frame periods, which are the first to the fourth frame periods, is (1+1+0.5+0.5)/4=¾ of the reference current value.

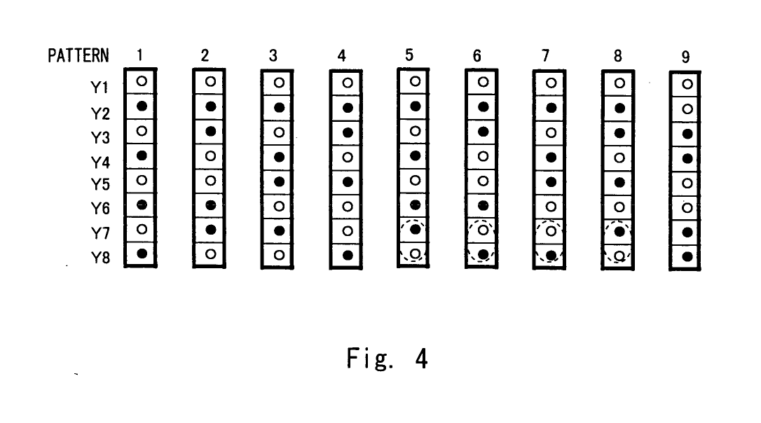

FIG. 4 illustrates eight display patterns concerning the present invention. The circle in FIG. 4 indicates that a bright (maximum luminance) data signal is supplied to the liquid crystal cell 8, and the black circle indicates that a dark (minimum luminance) data signal is supplied to the liquid crystal cell 8.

The display pattern 1 is “bright, dark, bright, dark, bright, dark, bright, dark”. The display pattern 1 is a maximum current pattern of the scan orders A and B. The display pattern 2 is “bright, dark, dark, bright, bright, dark, dark, bright.” The display pattern 2 is a maximum current pattern of the scan orders C and D. Further, the display pattern 2 is a maximum current pattern of the scan orders C′ and D′, which are explained in the fifth exemplary embodiment.

The display pattern 3 is “bright, dark, bright, dark, dark, bright, dark, bright”. The display pattern 3 is a maximum current pattern of the scan orders E and F described later. The display pattern 4 is “bright, dark, dark, bright, dark, bright, bright, dark”. The display pattern 4 is a maximum current pattern of the scan orders G and H described later. The display pattern 5 is “bright, dark, bright, dark, bright, dark, dark, bright”. The display pattern 5 is a maximum current pattern of the scan orders P and Q described later. The display pattern 6 is “bright, dark, dark, bright, bright, dark, bright, dark”. The display pattern 6 is a maximum current pattern of the scan orders R and S described later. The display pattern 7 is “bright, dark, bright, dark, dark, bright, bright, dark”. The display pattern 7 is a maximum current pattern of the scan orders T and U described later. The display pattern 8 is “bright, dark, dark, bright, dark, bright, dark, bright”. The display pattern 8 is a maximum current pattern of the scan orders V and W described later. Details of the scan orders E, F, G, H, P, Q, R, S, T, U, V, and W are explained later.

The display pattern 9 is “bright, bright, dark, dark, bright, bright, dark, dark”. In any of the scan orders in this exemplary embodiment, and also in the second to the fourth exemplary embodiments described later, the driving current of the data signals is ½ of the reference current value. Accordingly, the explanation of the driving current when displaying the display pattern 9 is omitted in the following explanation. This display pattern 9 is a maximum current pattern of the scan orders A′ and B′ of the fifth exemplary embodiment described later, and a part of the scan orders of the sixth exemplary embodiment.

The reversed display pattern of the display pattern 1 is “dark, bright, dark, bright, dark, bright, dark, and bright”, and this is referred to as a display pattern 1B. Similarly, the reversed display pattern of the display patterns 2 to 9 are respectively referred to as display patterns 2B to 9B.

In the present invention, in light of the driving current, the display patterns 1B to 9B are respectively considered the same display patterns as the display patterns 1 to 9. Further, for multiple data lines, a combination of display patterns composed of a display pattern j (j is from one to nine) and a display pattern jB, which is a reversed display pattern of the display pattern j, shall also be considered the same pattern as the display pattern j.

For example, the every other horizontal stripe pattern that displays the display pattern 1 for all the data lines, and the checkerboard pattern that alternately displays the display pattern 1 and the display pattern 1B by each data line shall be the same as the display pattern 1.

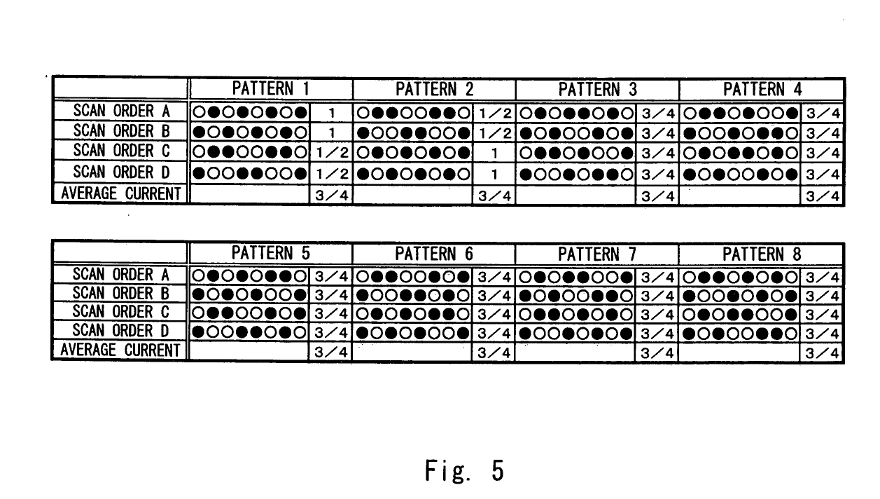

The driving current of the data signal is explained with reference to FIG. 5. The circle in FIG. 5 indicates that the data signal is bright, whereas the black circle indicates that the data signal is dark. Then, a data signal is supplied in the order from left to right in FIG. 5. The numbers beside the order of data signals (1, ½, and ¾) are compared current values against the reference current value in each scan order. Note that the present invention does not include the current consumption of the driving unit itself that has an amplifier for composing the data driver, and the current consumption of the logic unit.

First, the driving current of the data signals in each scan order A, B, C, and D for displaying a still image of the display pattern 1 is explained. As mentioned above, in the scan orders A and B, the driving current becomes the maximum when displaying the display pattern 1. On the other hand, the voltage levels of the data signals supplied in the scan order C are bright→dark→dark→bright→bright→dark→dark→bright (→bright), as illustrated in the third frame period of FIG. 3. The voltage levels of the data signals supplied in the scan order D are dark→bright→bright→dark→dark→bright→bright→dark (→dark), as illustrated in the fourth frame period of FIG. 3.

In the scan orders C and D, the voltage level changes four times, which are between the first and second scan periods, the third and fourth scan periods, the fifth and sixth scan periods, and the seventh and eighth scan periods. Therefore, the number of charge and discharge in the scan orders C and D is 4/8 of the data signal orders A and B, and the driving current is ½ (0.5) of the reference current value. By driving once or twice in each of the scan orders A, B, C, and D in four or eight frame periods, the average driving current in four or eight frame periods becomes (1+1+0.5+0.5)/4=¾. Therefore, in the display pattern 1, the driving current is reduced more than when driving in the scan order of a related art.

Next, the driving current of the data signals in each scan order A, B, C, and D when displaying a still image of the display pattern 2 is explained hereinafter. As mentioned above, in the scan orders C and D, the driving current becomes the maximum when displaying the display pattern 2. On the other hand, the voltage levels of the data signals supplied in the scan order A are bright→dark→dark→bright→bright→dark →dark→bright (→bright). The voltage levels of the data signals supplied in the scan order B are dark→bright→bright→dark→dark→bright→bright→dark (→dark).

In the scan orders A and B, the voltage level changes four times, which are between the first and second scan periods, the third and fourth scan periods, the fifth and sixth scan periods, and the seventh and eighth scan periods. Therefore, the number of charge and discharge in the scan orders A and B is 4/8 of the data signal orders A and B, and the driving current is ½ (0.5) of the reference current value. By driving once or twice in each of the scan orders A, B, C, and D in four or eight frame periods, the average driving current in four or eight frame periods becomes (1+1+0.5+0.5)4=¾.

The driving current when displaying the display pattern 2 in the scan order of a related art (scan order A) is ½ of the reference current value. Therefore, in the display pattern 2, the average driving current increases as compared to when driving in the scan order of a related art. Thus, the present invention concerns the technique to reduce the average driving current of data signals when displaying a particular display pattern (the display pattern 1 is the particular display pattern in the scan order A), and not the technique to reduce the average driving current of the data signals for all display patterns.

Next, the driving current of the data signals in each scan order A, B, C, and D when displaying a still image of the display pattern 3 is explained hereinafter. When displaying the display pattern 3, the voltage levels of the data signals supplied in the scan order A are bright→dark→bright→dark→dark→bright→dark→bright (→bright). The voltage levels of the data signals supplied in the scan order B are dark→bright→dark→bright→bright→dark→bright→dark (9 dark).

In the scan orders A and B, the voltage level does not change twice between the fourth and fifth scan periods, and the eighth and ninth scan periods. Therefore, the number of charge and discharge in the scan orders A and B is 4/8 of the data signal orders A and B, and the driving current is ½ (0.5) of the reference current value. The voltage levels of the data signals supplied in the scan order C are bright→dark→dark→bright→dark→bright→bright→dark (→bright). The voltage levels of the data signals supplied in the scan order D are dark→bright→bright→dark→bright→dark→dark→bright (→dark) in scan order D.

In scan orders C and D, the voltage level does not change twice between the second and third scan periods, and the sixth and seventh scan periods. Therefore, the number of charge and discharge in the scan orders C and D is 6/8 of the data signal orders A and B, and the driving current C and D is ¾ of the reference current value. The driving current is ¾ of the reference current value in any of the scan orders. Therefore, by driving once or twice in each of the scan orders A, B, C, and D in four or eight frame periods, the average driving current in four or eight frame periods is ¾ of the reference current value.

Next, the driving current of the data signal in each scan order A, B, C, and D when displaying a still image of the display pattern 4 is explained hereinafter. When displaying display pattern 4, the voltage levels of the data signals supplied in the scan order A are bright→dark→dark→bright→dark→bright→bright→dark (→bright). The voltage levels of the data signals supplied in the scan order B are dark→bright bright→dark→bright→dark→dark→bright (→dark). In the scan orders A and B, the voltage level does not change twice between the second and third scan periods, and the sixth and seventh scan periods. Therefore, the number of charge and discharge in the scan orders A and B is 6/8 of the data signal orders A and B, and the driving current is ¾ of the reference current value.

The voltage levels of the data signals supplied in the scan order C are bright→dark→bright→dark→dark→bright→dark→bright (→bright). The voltage levels of the data signals supplied in the scan order D are dark→bright→dark→bright→bright→dark→bright→dark (→dark). In the scan orders C and D, the voltage level does not change twice between the fourth and fifth scan periods, and the eighth and ninth scan periods. Thus the number of charge and discharge in the scan orders C and D is 6/8 of the data signal orders A and B. Thus the driving current in the scan orders C and D is ¾ of the reference current value. The driving current is ¾ of the reference current value in any of the scan orders. By driving once or twice in each of the scan orders A, B, C, and D in four or eight frame periods, the average driving current in four or eight frame periods is ¾ of the reference current value.

Next, the driving current of the data signal in each scan order A, B, C, and D when displaying a still image of the display pattern 2 is explained hereinafter. The display pattern 5 is a display pattern in which the voltage levels of liquid crystal cells “7” and “8” are reversed in the display pattern 1.

When displaying the display pattern 5, the voltage levels of the data signals supplied in the scan order A are bright→dark→bright→dark→bright→dark→dark→bright (→bright). The voltage levels of the data signals supplied in the scan order B are dark→bright→dark→bright→dark→bright→bright→dark (→dark). In the scan orders A and B, the voltage level does not change twice between the sixth and seventh scan periods, and the eighth and ninth scan periods. Therefore, the number of charge and discharge in the scan orders A and B is 6/8 of the data signal orders A and B, and the driving current is ¾ of the reference current value.

The voltage levels of the data signals supplied in the scan order C are bright→dark→dark→bright→bright→dark→bright→dark (→bright). The voltage levels of the data signals supplied in the scan order D are dark→bright→bright→dark→dark→bright→dark→bright (→dark) in scan order D. In the scan orders C and D, the voltage level does not change twice between the second and third scan periods, and the fourth and fifth scan periods. Thus the number of charge and discharge in the scan orders C and D is 6/8 of the data signal orders A and B, and the driving current is ¾ of the reference current value. By driving once or twice in each of the scan orders A, B, C, and D in four or eight frame periods, the average driving current in four or eight frame periods is ¾ of the reference current value.

The display pattern 6 is a display pattern in which the voltage levels of liquid crystal cells “7” and “8” are reversed in the display pattern 2. The display pattern 7 is a display pattern in which the voltage levels of liquid crystal cells “7” and “8” are reversed in the display pattern 3. The display pattern 8 is a display pattern in which the voltage levels of liquid crystal cells “7” and “8” are reversed in the display pattern 4. Although the details are omitted, the average driving current of four or eight frame periods is ¾ of the reference current value in any of the display patterns 6 to 8. Therefore, in the display patterns 3 to 8, the driving current does not change as compared to the scan order of a related art.

There is only the display pattern 1 that the driving current of the data signals becomes the maximum current at the time of column inversion driving in the scan order of a related art. As described above, this is because that the reversed display pattern 1B is considered to be the same display pattern as the display pattern 1.

On the other hand, in this exemplary embodiment, there are multiple display patterns in which the average driving current becomes the maximum current. The average driving current of four or eight frame periods is ¾ of the reference current value in any of the display patterns 1 to 8, and the reversed display patterns 1B to 8B in FIG. 4. By the way, there are 256 different combinations to supply bright and dark data signals in the eight scan periods. Above all, there are 128 different combinations that start with bright, and 35 different combinations to supply four bright and four dark data signals. Among the 35 different combinations, there are eight display patterns in which the average driving current becomes ¾ (0.75) of the reference current value, 16 display patterns to be 9/16 (0.5625), nine display patterns to be ½ (0.5), and two ways of display patterns to be ¼ (0.25). The average driving current of the display patterns 1 to 8 illustrated in FIG. 4 is ¾ of the reference current value in this exemplary embodiment.

Among 128 different combinations that start with bright, there are 56 different combinations that supply three bright signals and five dark signals or five bright signals and three dark signals. The maximum value of the average driving current at this time is ⅝ (0.625) of the reference current value.

Therefore, by performing column inversion driving in the scan order of this exemplary embodiment, the average driving current of the data signals is ¾ or less of the reference current value in all the display patterns. That is, as the maximum value of the average driving current is low as compared to a case of column inversion driving in the scan order of a related art, thus the highest attainable temperature of the data driver 3 can be reduced.

In the column inversion driving of the scan order of a related art (the scan order A), the voltage level of the previous data signal causes uneven brightness, however there are display patterns that reduces the uneven brightness in this exemplary embodiment. The display pattern includes horizontal stripe pattern (dark, dark, middle, middle, dark, dark, middle, middle). The halftone of the luminance is referred to as “middle” here. In the halftone, luminance difference is easily recognizable, and in the scan order of a related art, if the data signal before a halftone data signal is dark, it is displayed slightly darker than the original luminance.

However, according to this exemplary embodiment, in the multiple liquid crystal cells 8 which are connected to the same data line X, the liquid crystal cell “2k−1 (or liquid crystal cell “2k”) is influenced twice by data signals supplied to another liquid crystal cell “2k” (or liquid crystal cell “2k−1”) that belongs to the same scan group, and influenced once each by data signals supplied to the liquid crystal cell “2k−3” and the liquid crystal cell “2k−2” that belongs to previous scan group.

For example, if the data signals of dark, dark, middle, middle are supplied respectively to the liquid crystal cells “2k−3”, “2k−2”, “2k−1”, and “2k”, two dark and two middle data signals are supplied to the liquid crystal cells “2k−1” and “2k” as previous data signals in the four frame periods, thereby improving the uneven brightness.

### Second Exemplary Embodiment

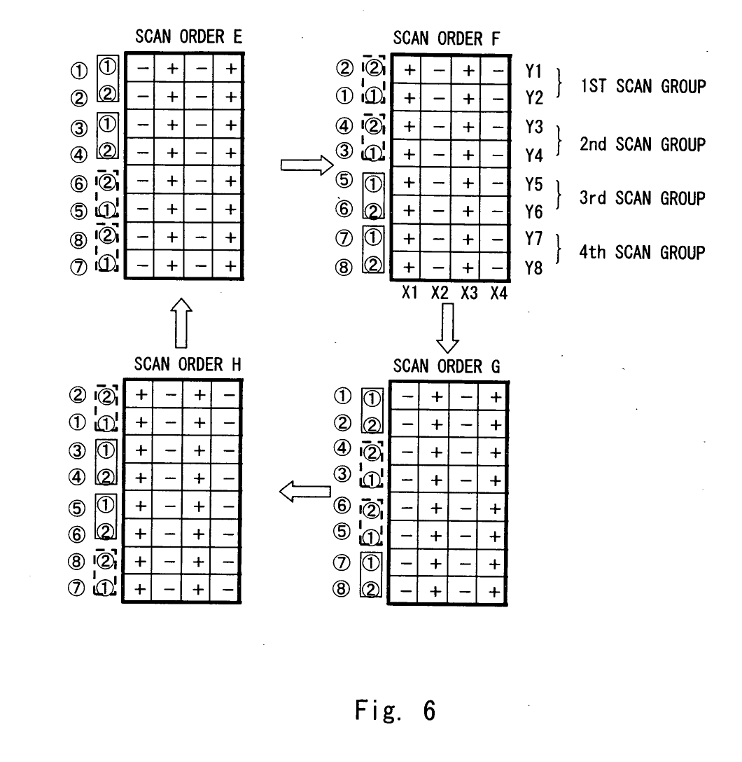

A driving method of a display panel according to a second exemplary embodiment of the present invention is explained with reference to FIGS. 6 to 8. This exemplary embodiment explains an example of using the scan orders E, F, G, and H instead of the scan order A, B, C, and D of the first exemplary embodiment. Note that the display device with similar configuration as FIG. 1 can be used for the display device, thus the explanation is omitted. FIG. 6 illustrates the scan orders of each scan line in one scan block in this exemplary embodiment.

In the scan order E, the first and second scan groups are forward scan, and the third and fourth scan groups are backward scan. That is, the scan lines are driven in the order of Y1→Y2→Y3→Y4→Y6→Y5→Y8→Y7. In the scan order F, the first and second scan groups are backward scan, and the third and fourth scan groups are backward scan. That is, the scan lines are driven in the order of Y2→Y1→Y4→Y3→Y5→Y6→Y8.

In the scan order G, the first and fourth scan groups are forward scan, and the second and third scan groups are backward scan. That is, the scan lines are driven in the order of Y1→Y2→Y4→Y3→Y6→Y5→Y7→Y8. In the scan order H, the first and fourth scan groups are backward scan, and the second and third scan groups are forward scan. That is, the scan lines are driven in the order of Y2→Y1→Y3→Y4→Y5→Y6→Y8→Y7.

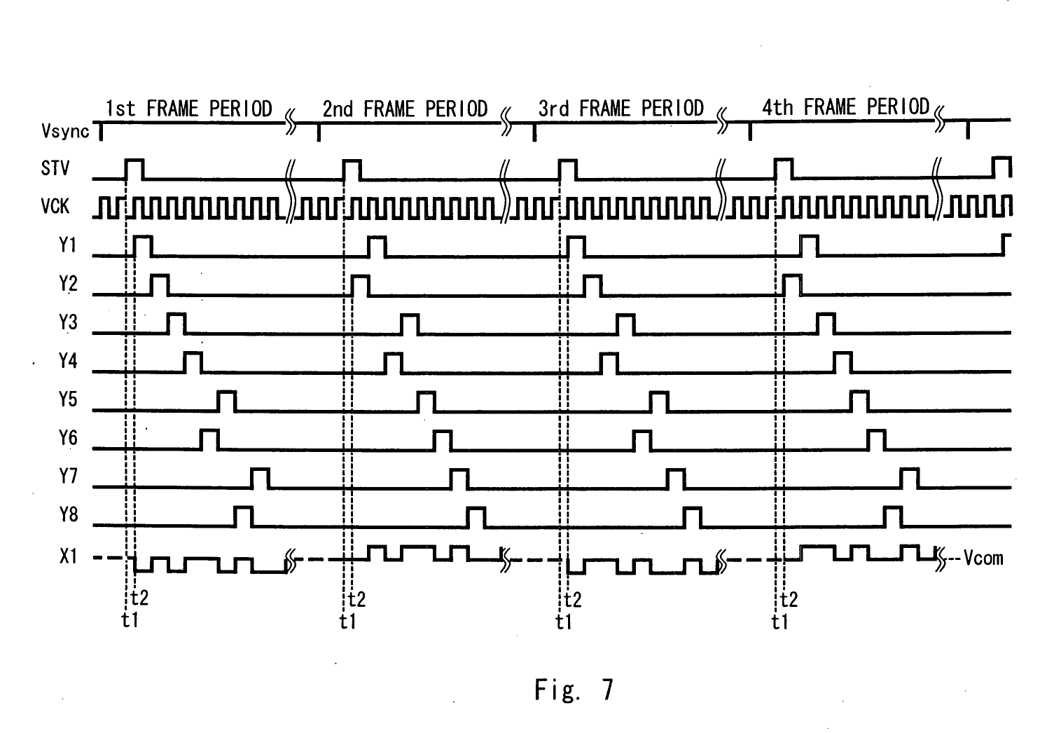

Next, the driving method according to this exemplary embodiment is explained with reference to FIG. 7. FIG. 7 is a timing chart for explaining the driving method of the display panel according to this exemplary embodiment. As illustrated in FIG. 7, if the vertical synchronization signal Vsync is input to the timing controller 5, a vertical start signal STV is input to the gate driver 4 at the time t1 of each frame period according to a clock signal VCLK, and then a first scan process is started in each frame period at the following time T2.

In the first frame period, eight scan lines in each scan block are driven in the scan order E described with reference to FIG. 6. In the second frame period following the first frame period, eight scan lines in each scan block are driven in the scan order F. In the third frame period following the second frame period, eight scan lines in each scan block are driven in the scan order G. In the fourth frame period following the third frame period, eight scan lines in each scan block are driven in the scan order H.

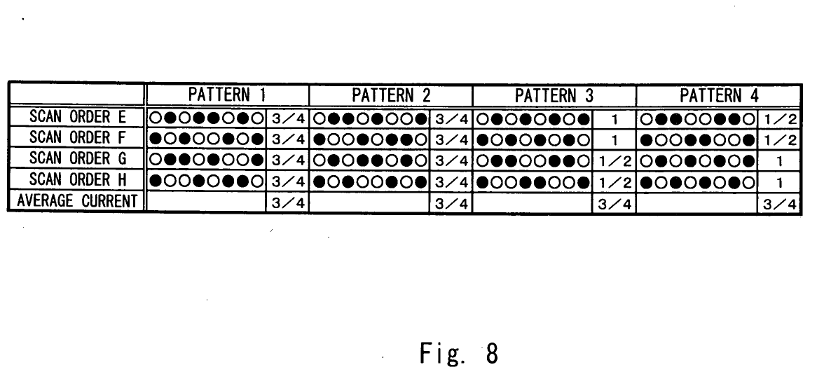

The driving current of data signals is explained with reference to FIG. 8. First, the driving current of the data signal in each scan order E, F, G, and H when displaying a still image of the display pattern 1 is explained hereinafter.

When displaying the display pattern 1, the voltage levels of the data signals supplied in the scan order E are bright→dark→bright→dark→dark→bright→dark→bright (→bright). The voltage levels of the data signals supplied in the scan order F are dark→bright→dark→bright→bright→dark→bright→dark (→dark). In the scan orders E and F, the voltage level does not change twice between the fourth and fifth scan periods, and the eighth and ninth scan periods. Therefore, the number of charge and discharge in the scan orders E and F is 6/8 of the data signal orders A and B, and the driving current is ¾ of the reference current value.

The voltage levels of the data signals supplied in the scan order G are bright→dark→dark→bright→dark→bright→bright→dark (→bright). The voltage levels of the data signals supplied in the scan order H are dark→bright→bright→dark→bright→dark→dark→bright (→dark). In the scan orders G and H, the voltage level does not change twice between the second and third scan periods, and the sixth to seventh scan periods. Therefore, the number of charge and discharge in the scan orders G and H is 6/8 of the data signal orders A and B, and the driving current is ¾ of the reference current value. By driving once or twice in each of the scan orders E, F, G, and H in four or eight frame periods, the average driving current in four or eight frame periods is ¾ of the reference current value.

Next, the driving current of the data signals in each scan order E, F, G, and H when displaying a still image of the display pattern 2 is explained hereinafter. When displaying the display pattern 2, the voltage levels of the data signals supplied in the scan order E are bright→dark→dark→bright→dark→bright→bright→dark (→bright). The voltage levels of the data signals supplied in the scan order F are dark→bright→bright→dark→bright→dark→dark→bright (→dark). In the scan orders E and F, the voltage level does not change twice between the second and third scan periods, and the sixth and seventh scan periods. Therefore, the number of charge and discharge in the scan orders E and F is 6/8 of the data signal orders A and B, and the driving current is ¾ of the reference current value.

The voltage levels of the data signals supplied in the scan order G are bright→dark→bright→dark→dark→bright→dark→bright (→bright). The voltage levels of the data signals supplied in the scan order H are dark→bright→dark→bright→bright→dark→bright→dark (→dark) in the scan order H. In the scan orders G and H, the voltage level does not change twice between the fourth and fifth scan periods, and the eighth and ninth scan periods. Therefore, the number of charge and discharge in the scan orders G and H is 6/8 of the data signal orders A and B, and the driving current is ¾ of the reference current value. By driving once or twice in each of the scan orders E, F, G, and H in four or eight frame periods, the average driving current in four or eight frame periods becomes ¾ of the reference current value.

Next, the driving current of the data signal in each scan order E, F, G, and H when displaying a still image of the display pattern 3 is explained hereinafter. As mentioned above, in the scan orders E and F, the driving current becomes the maximum when displaying the display pattern 1. On the other hand, the voltage levels of the data signals supplied in the scan order G are bright→dark→dark→bright→bright dark→dark→bright (→bright). The voltage levels of the data signals supplied in the scan order H are dark→bright→bright→dark→dark→bright→bright→dark (→dark) in scan order H.

In the scan orders G and H, the voltage level changes four times, which are between the first and second scan periods, the third and fourth scan periods, the fifth and sixth scan periods, and the seventh and eighth scan periods. Therefore, the number of charge and discharge in the scan orders G and H is 4/8 of the data signal orders A and B, and the driving current is ½ of the reference current value. By driving once or twice in each of the scan orders E, F, G, and H in four or eight frame periods, the average driving current in four or eight frame periods becomes (1+1+0.5+0.5)4=¾.

Next, the driving current of the data signals in each scan order E, F, G, and H when displaying a still image of the display pattern 4 is explained hereinafter. As mentioned above, the driving current becomes the maximum current when displaying the display pattern 4 in the scan orders G and H. On the other hand, the voltage levels of the data signals supplied in the scan order E are bright→dark→dark→bright→bright→dark→dark→bright (→bright). The voltage levels of the data signals supplied in the scan order F are dark→bright→bright→dark→dark→bright→bright→dark (→dark).

In the scan orders E and F, the voltage level changes four times, which are between the first and second scan periods, the third and fourth scan periods, the fifth and sixth scan periods, and the seventh and eighth scan periods. Therefore, the number of charge and discharge in the scan orders E and F is 4/8 of the data signal orders A and B, and the driving current is ½ of the reference current value. By driving once or twice in each of the scan orders E, F, G, and H in four or eight frame periods, the average driving current in four or eight frame periods becomes (1+1+0.5+0.5)4=¾.

Although not illustrated in FIG. 8, similarly the average driving current in four or eight frame periods in each scan order E, F, G, and H when displaying a still image of the display patterns 5 to 8, and the display patterns 1B to 8B is ¾ of the reference current value.

There are six frame orders for the order between frames of the scan orders E, F, G, and H, as with the scan orders A, B, C, and D. In consideration of polarity, the scan order may be in the order of E(negative)→scan order G(positive) scan order F(negative) scan order H(positive) scan order G(negative) scan order E(positive) scan order H(negative) scan order F (positive), for example.

### Third Exemplary Embodiment

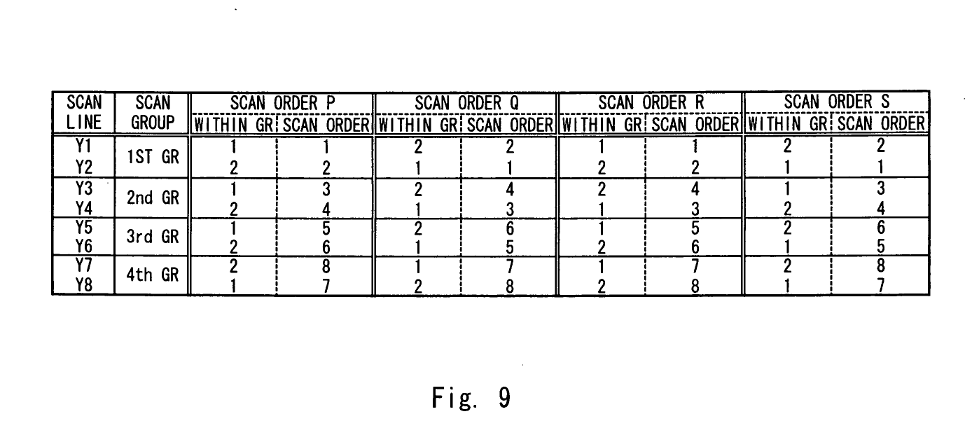

A driving method of a display panel according to a third exemplary embodiment of the present invention is explained with reference to FIG. 9. This exemplary embodiment explains the example of using scan order P, Q, R, and S instead of the scan orders A to D, and E to H in the first and second exemplary embodiments. Note that the display device with similar configuration as FIG. 1 can be used for the display device, thus the explanation is omitted. FIG. 9 illustrates the scan order of each scan line in one scan block in this exemplary embodiment.

In the scan order P, the first, second, and third scan groups are forward scan, and the fourth scan is backward scan. That is, the scan lines are driven in the order of Y1→Y2→Y3→Y4→Y5→Y6→Y8→Y7. In the scan order Q, the first, second, and third scan groups are backward scan, and the fourth scan group is forward scan. That is, the scan lines are driven in the order of Y2→Y1→Y4→Y3→Y6→Y5→Y7→Y8.

In the scan order R, the first, third, and fourth scan groups are forward scan, and the second scan group is backward scan. That is, the scan lines are driven in the order of Y1→Y2→Y4→Y3→Y5→Y6→Y7→Y8. In the scan order S, the first, third, and fourth scan groups are backward scan, and the second scan group is forward scan. That is, the scan lines are driven in the order of Y2→Y1→Y3→Y4→Y6→Y5→Y8→Y7.

Although details are omitted, in each of the scan orders P, Q, R, and S, the driving current of the data signals for displaying the display patterns 1 to 4, and 7 and 8 is ¾ of the reference current value. By driving once or twice in each of the scan orders P, Q, R, and S in four or eight frame periods, the average driving current in four or eight frame periods becomes ¾ of the reference current value.

In the scan orders P and Q, the same current as the reference current value of a data signal flows when displaying the display pattern 5. In the scan orders R and S, the driving current of the data signals when displaying the display pattern 5 is ½ of the reference current value. By driving once or twice in each of the scan orders P, Q, R, and S in four or eight frame periods, the average driving current in four or eight frame periods becomes ¾ of the reference current value. The order between frames in the scan orders P, Q, R, and S is similar to the first and second exemplary embodiment, thus explanation is omitted.

### Fourth Exemplary Embodiment

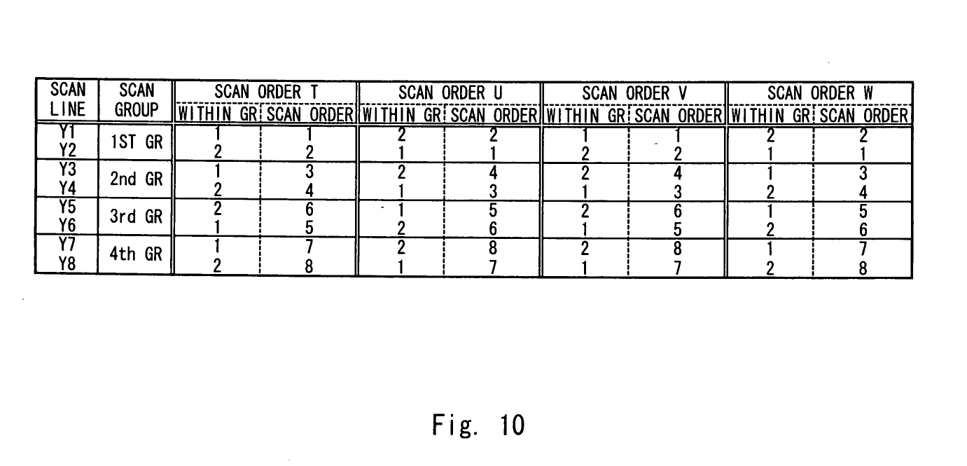

The driving method of the display panel according to the fourth exemplary embodiment of the present invention is explained with reference to FIG. 10. This exemplary embodiment explains the example which uses scan order T, U, V, and W instead of the scan orders A to D, and E to H, and P to S in the first, second, and third exemplary embodiments. Note that the display device with similar configuration as FIG. 1 can be used for the display device, the explanation is omitted. FIG. 10 illustrates a scan order of each scan line in one Scan block in this exemplary embodiment.

In the scan order T, the first, second, and fourth scan groups are forward scan, and the third scan group is backward scan. That is, the scan lines are driven in the order of Y1→Y2→Y3→Y4→Y6→Y5→Y7→Y8. In the scan order U, the first, second, and fourth scan groups are backward scan, and the third scan group is forward scan. That is, the scan lines are driven in the order of Y2→Y1→Y4→Y3→Y5→Y6→Y8→Y7.

In the scan order V, the second, third, and fourth scan groups are backward scan, and the first scan group is forward scan. That is, the scan lines are driven in the order of Y1→Y2→Y4→Y3→Y6→Y5→Y8→Y7. In the scan order W, the second, third, and fourth scan groups are forward scan, and the first scan group is backward scan. That is, the scan lines are driven in the order of Y2→Y1→Y3→Y4→Y5→Y6→Y7→Y8.

Although details are omitted, in each of the scan orders T, U, V, and W, the driving current of the data signals for displaying the display patterns 1 to 6 is ¾ of the reference current value. By driving once or twice in each of the scan orders T, U, V, and W in four or eight frame periods, the average driving current in four or eight frame periods becomes ¾ of the reference current value.

The driving current when displaying the display pattern 7 in the scan orders T and U is the same current as the reference current value. In the scan orders V and W, the driving current of the data signals for displaying the display pattern 8 is ½ of the reference current value. By driving once or twice in each of the scan orders T, U, V, and W in four or eight frame periods, the average driving current in four or eight frame periods becomes ¾ of the reference current value. The order between frames in the scan orders T, U, V, and W is similar to the first and second exemplary embodiments, thus explanation is omitted.

### Fifth Exemplary Embodiment

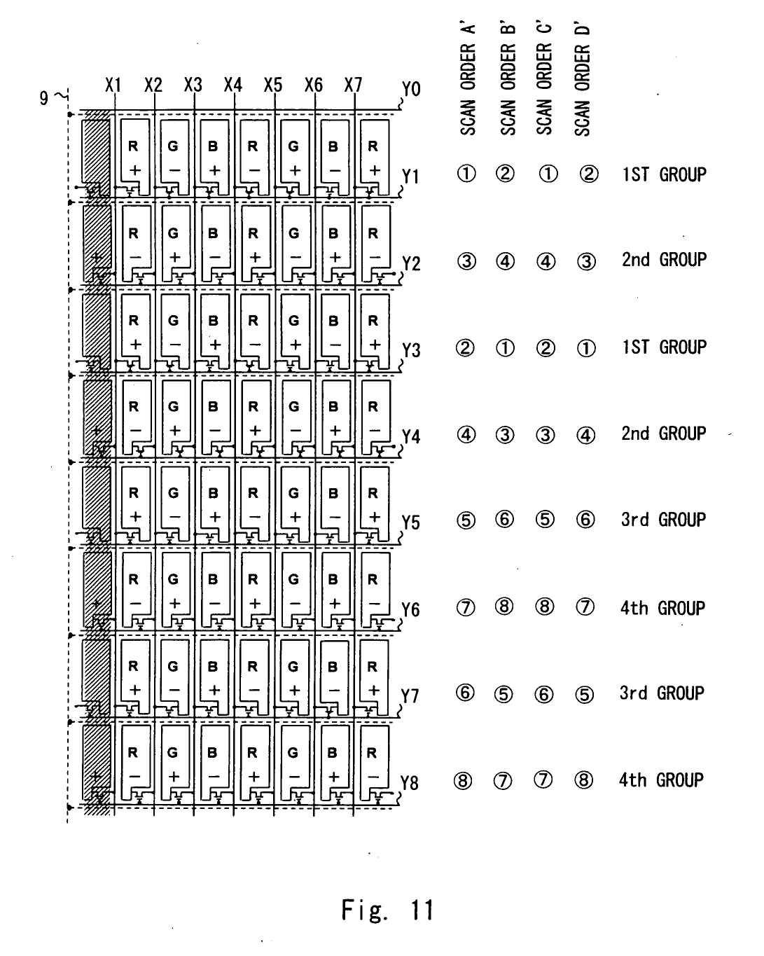

In general, the column inversion driving is known to generate flickers in the vertical stripe pattern. This exemplary embodiment adopts the arrangement of liquid crystal cells 8 explained below in order to reduce this flicker. FIG. 11 is an arrangement example of the liquid crystal cells in a display panel for explaining a driving method of a display panel according to the present invention.

As illustrated in FIG. 11, the liquid crystal cells 8 are formed respectively between the scan lines Y0 to Y8, and the data lines X1 to X7, which are formed in a grid pattern. The liquid crystal cells 8 of eight rows×eight columns are illustrated in FIG. 11. The shaded column (i=0) in the drawing is a dummy column.

In this exemplary embodiment, multiple liquid crystal cells 8 placed in the ith column (where i is an integer of zero or more, and i=0 is a dummy column) are alternately connected to the data line Xi and the data line Xi+1 by one row (one scan line). Note that the data line Xi and the data line Xi+1 are left and right adjacent. Specifically, in the first column, each liquid crystal cell 8, which is the liquid crystal cells “1”, “3”, “5”, . . . , and “1079”, in the odd numbered rows is respectively connected to the data line X1. Each liquid crystal cell 8, which is the liquid crystal cells “2”, “4”, “6”, . . . , “1080”, in the even numbered rows is respectively connected to the data line X2.

In the second column, each liquid crystal cell 8, which is the liquid crystal cells “1”, “3”, “5”, . . . , and “1079”, in the odd numbered rows is respectively connected to the data line X2. Each liquid crystal cell 8, which is the liquid crystal cells “2” “4”, “6”, . . . , “1080”, in the even numbered rows is respectively connected to the data line X3. The third column and subsequent columns are formed in a similar manner as the first and second columns, thus the explanation is omitted. Accordingly, in the display panel illustrated in FIG. 11, the liquid crystal cells 8 in one column are connected to different and adjacent data lines X alternately by each row. The liquid crystal cells 8 are arranged in a zigzag pattern in the display panel. Hereafter, this arrangement is referred to as one-step zigzag arrangement.

As with the first to fourth exemplary embodiments, the voltage polarities of the data signals are reversed for each frame period. Therefore, the voltage polarity of each liquid crystal cell 8 is reversed for every frame period. The one-step zigzag arrangement illustrated in FIG. 11 achieves pseudo 1H dot inversion display. Therefore, the flicker in the vertical stripe pattern can be reduced. Note that each liquid crystal cell 8 in the dummy column formed to the leftmost (or rightmost) is shielded from light.

In the first to fourth exemplary embodiments, the scan lines composing one scan group is two continuous scan lines. However, in this exemplary embodiment, the scan lines composing a scan group are two alternate scan lines. That is, the dth scan groups (d is one or more odd number) are scan lines Y2d−1 and Y2d+1. The eth scan group (e is two or more even number) is scan lines Y2e−2 and Y2e.

Specifically, the first scan group is composed of the scan lines Y1 and Y3, the second scan group is composed of the scan lines Y2 and Y4, the third scan group is composed of the scan lines Y5 and Y7, the fourth scan group is composed of Y6 and Y8, . . . the 539th scan group is composed of the scan lines Y1077 and Y1079, and the 540th scan group is composed of the scan lines Y1078 and Y1080. Also in this exemplary embodiment, the scan groups are driven in the order of first scan group→second scan group→third scan group→fourth scan group→, . . . , the 539th scan group→540th scan group.

This exemplary embodiment applies the scan orders explained in the first to fourth exemplary embodiments. For example, referring to the first exemplary embodiment, in the scan order A′, the scan lines are driven in the order of Y1→Y3→Y2→Y4→Y5→Y7→Y6→Y8, in the first to eighth scan periods. In the scan order B′, the scan lines are driven in the order of Y3→Y1→Y4→Y2→Y7→Y5→Y8→Y6. In the scan order C′, the scan lines are driven in the order of Y1→Y3→Y4→Y2→Y5→Y7→Y8→Y6. In the scan order D′, the scan lines are driven in the order of Y3→Y1→Y2 →Y4→Y7→Y5→Y6→Y8. At this time, the maximum current pattern of the scan orders A′ and B′ is the display pattern 9. The maximum current pattern of the scan orders C′ and D′ is the display pattern 2.

Next, referring to the second exemplary embodiment, in the scan order E′, the scan lines are driven in the order of Y1→Y3→Y2→Y4→Y7→Y5→Y8→Y6, in the first to eighth scan periods. In the scan order F′, the scan lines are driven in the order of Y3→Y1→Y4→Y2→Y5→Y7→Y6→Y8. In the scan order G′, the scan lines are driven in the order of Y1→Y3→Y4→Y2→Y7→Y5→Y6→Y8. In the scan order H′, the scan lines are driven in the order of Y3→Y1→Y2→Y4→Y5→Y7→Y8→Y6.

The maximum current pattern of the scan orders E′ and F′ are the same. The maximum current pattern of the scan orders G′ and H′ are the same. Four scan orders, which are the scan orders E′, F′, G′, and H′, are switched and driven by one or two frame period. The scan orders P′, Q′, R′ and S′ applying the third exemplary embodiment, and the scan orders T′, U′, V′, and W′ applying the fourth exemplary embodiment are similar to the scan orders E′, F′, G′, and H′, thus the detailed explanation is omitted.

The exemplary advantage to reduce the driving current of the data signals is the same as the first to fourth exemplary embodiments, and the average driving current of the data signal becomes ¾ or less in all the display patterns. According to this exemplary embodiment, the average driving current when displaying the display pattern 1, such as the horizontal stripe pattern of every other scan line, becomes ½ of the reference current value. In the liquid crystal display panel for use with higher appearance frequency of the horizontal stripe pattern of every other line than the horizontal stripe pattern of every two scan lines, it is preferable to drive the scan lines as in this exemplary embodiment.

In the liquid crystal display panel 2 of the one-step zigzag arrangement illustrated in FIG. 11, if column inversion driving is performed only in the scan order of a related art (only the scan order A), and by displaying single color pattern (solid pattern) of red, green, blue colors having high appearance frequency, the contrast of the liquid crystal cells 8 is reduced near the far end part of the data line X, which is located far from the data driver 3.

For example, in order to display a green solid pattern, the same dark data signals are supplied to the data lines X1 and X4 in eight scan periods. The data signals of bright→dark→bright→dark→bright→dark→bright→dark are supplied to the data lines X2 and X5 in eight scan periods. The data signals of dark→bright→dark→bright→dark→bright→dark→bright are supplied to the data lines X3 and X6 in eight scan periods. In the data lines X2, X3, X5, and X6 that drive the green liquid crystal cells 8, the data signal in one scan period before bright is dark. Thus slightly dark green color appears due to wave rounding of the data signal near the far end of the data line X.

Further, in the liquid crystal display panel 2 of the one-step zigzag arrangement illustrated in FIG. 11, if column inversion driving is carried out only in the scan order A′ to display red, green, and blue solid patterns with high appearance frequency, the driving current is reduced by half as compared to when carrying out a column inversion driving in the scan order of a related art (only in the scan order A). However, in the liquid crystal cells 8 near the far end part of the data line X, which is located far from the data driver 3, uneven brightness is generated due to waveform rounding.

On the other hand, if column inversion driving is carried out in the scan order of this exemplary embodiment and a green solid pattern is displayed, the same dark data signals are supplied to the data lines X1 and X4 in eight scan periods. The data signals of bright→bright→dark→dark→bright→bright→dark→dark are supplied to the data lines X2 and X5 in eight scan periods. The data signals of dark→dark→(bright→bright)→dark→dark→bright→bright are supplied to the data lines X3 and X6 in eight scan periods.

Now take notice to the green liquid crystal cell “2” in the second row, which is interposed between the data lines X2 and X3, and connected to the data line X3. This liquid crystal cell “2” is driven in the third scan period in the scan orders A′ and D′, and is driven in the fourth scan period in the scan orders B′ and C′. Needless to say that the third scan line is influenced by the data signals in the second scan period, and the fourth scan period is influenced by the data signals of the third scan period.

That is, in the two frame periods that are driven in the scan orders A′ and D′ among four frame periods, the data signal of one scan period before is dark. However in two frame periods driven in the scan orders B′ and C′, the data signal of one scan period before is bright, thereby slightly improving the contrast. In a similar manner for other rows, there are continuous bright data signals in the two scan orders among the four scan orders, thus improving the contrast. The driving current at this time is reduced by half compared to the driving current of the scan order or a related art (only the scan order A).

Further, in the liquid crystal display panel 2 of the one-step zigzag arrangement illustrated in FIG. 11, if column inversion driving is performed in the scan order of a related art (only the scan order A) to display cyan, magenta, and yellow solid patterns, uneven brightness is generated in one other scan line near far end part of the data line. For example, in order to display the yellow solid pattern, the data signals of bright→dark→bright→dark→bright→dark→bright→dark are supplied the data lines X1 and X4 in eight scan periods. The same bright data signals are supplied to the data lines X2 and X5 in eight scan periods. The data signals of dark→bright→dark→bright→dark→bright→dark→bright are supplied to the data lines X3 and X6 in eight scan periods. As the voltage level does not change for the data lines X2 and X5, the waveform rounding is not generated. However, as the voltage level changes by each scan period for the data lines X1, X3, X4, and X6, the data signals cannot be written sufficiently to the pixel electrode 7 due to waveform rounding.

On the other hand, if column inversion driving is carried out by the scan order of this exemplary embodiment and to display the solid pattern of yellow, the data signals of bright→bright→dark→dark→bright→bright→dark→dark are supplied to the data lines X1 and X4 in eight scan periods. The same bright data signal is supplied to the data lines X2 and X5 over eight scan periods. The data signals of dark→dark →bright → bright→dark→dark→bright → bright are supplied to the data lines X3 and X6 in eight scan periods.

Now take notice to the green liquid crystal cell “2” in the second row, which is interposed between the data lines X2 and X3, and connected to the data line X3. Two frame periods of the scan orders A′ and D′ are driven in the third scan period, and a previous data signal is dark. Two frame periods of the scan orders B′ and C′ are driven in the fourth scan period, and a previous data signal is bright. Accordingly, as there are continuous bright data signals in the two frames among the four frame periods, insufficient writing to the pixel electrode can be slightly improved.

Next, the setting procedure of the scan order common to the first to fifth exemplary embodiments is explained. The setting procedure of the scan order of eight continuous scan lines (four scan groups) is illustrated below.

a. Any one scan order shall be the first scan order.
b. The second scan order is obtained by reversing (forward scan → backward scan, and backward scan→forward scan) the scan orders in the odd numbered scan groups (the first and third scan groups) in the first scan order.
c. The third scan order is obtained by reversing the scan orders in each scan group in the first scan order.
d. The fourth scan order is obtained by reversing the scan orders in each scan group in the second scan order. In other words, the fourth scan order is obtained by reversing the scan orders in the even numbered scan groups in the first scan order.

In the setting procedure of the abovementioned scan order, the second scan order may also be obtained by reversing the even numbered scan groups (the second and fourth scan groups) in the first scan order. In this case, the fourth scan order is obtained by reversing the scan orders in the odd numbered scan groups in the first scan order.

A display pattern (maximum current pattern), in which eight scan lines are driven in the first scan order, a voltage level of a data signal changes by each scan period, and the number of charge and discharge becomes the maximum number, is referred to as a first maximum current pattern. Further, a display pattern (maximum current pattern), in which eight scan lines are driven in the second scan order, a voltage level of a data signal changes by each scan period, and the number of charge and discharge becomes the maximum number, is referred to as a second maximum current pattern.

Thus, the maximum current pattern of the third scan order is the first maximum current pattern. Moreover, the maximum current pattern of the fourth scan order is the second maximum current pattern. Then, the driving current of the data signals when displaying the first maximum current pattern in the second or fourth scan orders is ½ of the reference current value. Further, the driving current of the data signals when displaying the second maximum current pattern in the first or third scan order is ½ of the reference current value.

For example, in first exemplary embodiment, if the first scan order is the scan order A, the second scan order is the scan order D, the third scan order is the scan order B, and the fourth scan order is the scan order C. Then, the first maximum current pattern is the display pattern 1, and the second maximum current pattern is the display pattern 2. The driving current of the data signals when displaying the display pattern 1 in the scan orders D and C, which are the second and fourth scan orders, is ½ of the reference current value. The driving current of the data signals when displaying the display pattern 2 in the scan orders A and B, which are the first and third scan orders, is ½ of the reference current value.

As another example, in the second exemplary embodiment, if the first scan order is the scan order E, the second scan order is the scan order H, the third scan order is the scan order F, and the fourth scan order is the scan order G. Then, the first maximum current pattern is the display pattern 3, and the second maximum current pattern is the display pattern 4. The driving current of the data signals when displaying the display pattern 3 in the scan orders H and G, which are the second and fourth scan orders, is ½ of the reference current value. Further, the driving current of the data signals when displaying the display pattern 4 in the scan orders E and F, which are the first and third scan orders, is ½ of the reference current value.

In the first to fifth exemplary embodiment, by switching and driving the first and second scan orders or the first and the fourth orders by one or two frame periods, the average driving current of the driving signals can be reduced. However, short driving period reduces the image quality. On the contrary, by switching and driving the first and third scan orders by one or two frame periods, the image quality improves but the average driving current cannot be reduced. By switching and driving the four scan orders, which are the first to fourth scan orders, by one or two frame periods, it is possible to reduce the average driving current of the data signals to be ¾ or lower of the reference current value and also improve the image quality.

In the scan order explained in the fifth exemplary embodiment, some liquid crystal cells 8 receive coupling noise in the early stage after one to three scan periods after the data signals are written, while other liquid crystal cells 8 receive coupling noise in the later stage after about one frame period after the data signals are written. Even if the liquid crystal cells receive coupling noise after the about one frame period after data signals are written, the liquid crystal cells have already responded with correct data signals. Thus, this will not be a problem. The problem on the image quality is the liquid crystal cells 8 that receive coupling noise in the early stage.

The liquid crystal cells 8 that receive the coupling noise in the early stage are explained hereinafter. The liquid crystal cell “1” receives the influence of the coupling noise from the pixel electrode 7 of the liquid crystal cell “2” only once in the early stage. The liquid crystal cell “2” is not influenced by the coupling noise from the pixel electrode 7 of another row in the early stage. The liquid crystal cell “3” receives the influences of the coupling noise from the pixel electrodes 7 of the liquid crystal cells “2” and “4”, once each in the early stage, which is a total of twice. The liquid crystal cell “4” receives the influence of the coupling noise from the pixel electrode 7 of the liquid crystal cell “5” once in the early stage. Thus, since the number of receiving the influence of the coupling noise differs in each row, the image quality is reduced unless suppressing the coupling noise between the pixel electrode 7 and another pixel electrode 7.

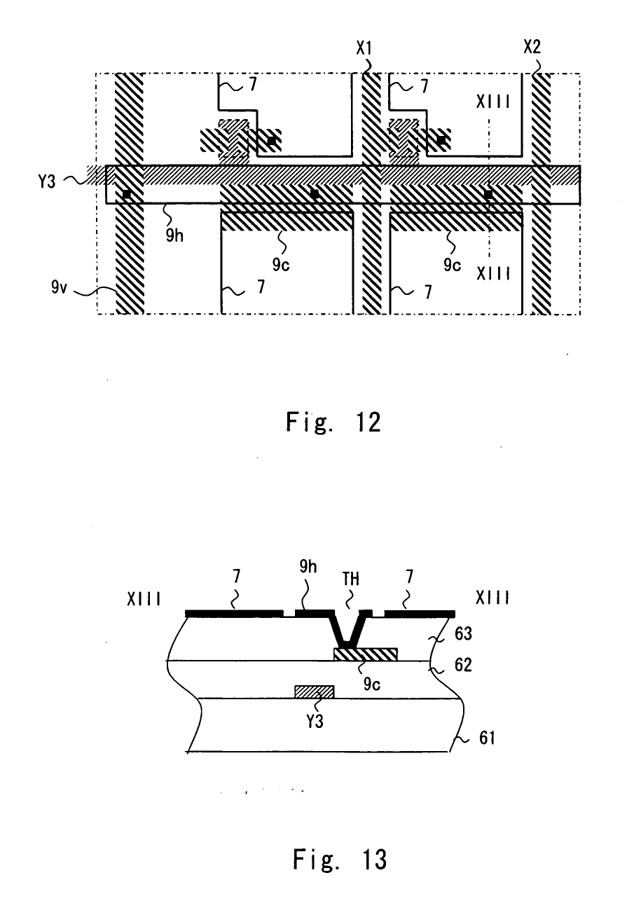

The configuration of the liquid crystal cell 8 for suppressing this coupling noise is explained with reference to FIGS. 12 and 13. FIG. 12 is a plan view illustrating the configuration near the scan line of the display panel illustrated in FIG. 11. FIG. 13 is a cross-sectional diagram taken along the line XIII-XIII of FIG. 12 including the through hole TH. Note that FIGS. 12 and 13 illustrates in order to clarify the physical relationship of the pixel electrode 7, the scan line Y, and the auxiliary capacitance line 9. Thus in FIGS. 12 and 13, a semiconductor layer, such as an amorphous silicon, a liquid crystal layer, an upper glass substrate, a color filter, a black matrix, a common electrode, an oriented film, a polarizing plate, etc. are not illustrated.

The auxiliary capacitance line 9 includes a vertical auxiliary capacitance line 9v that extends in the vertical direction outside the display area of the liquid crystal display panel 2, a horizontal auxiliary capacitance line 9h that extends in the horizontal direction inside the display area of the liquid crystal display panel 2, and a cell auxiliary capacitance line 9c provided in each liquid crystal cell 8. A fixed voltage equal to Vcom is supplied to the auxiliary capacitance lines 9v, 9h, and 9c.

The scan line Y is formed in the first layer above a lower glass substrate 61 to extend in the horizontal direction. The data line X is formed in the second layer above a first insulating film 62 to extend in the vertical direction. The pixel electrode 7 is formed in the third layer above a second insulating film 63. The pixel electrode 7 is formed of a transparent thin metal film, such as ITO (Indium Tin Oxide).

The horizontal auxiliary capacitance line 9h is formed between the pixel electrode and the pixel electrode 7 of another adjacent row in the third layer above the scan line Y to extend in the horizontal direction. Since the horizontal auxiliary capacitance line 9h is formed in the same layer as the pixel electrode 7, it is formed of ITO. Note that the horizontal auxiliary capacitance line 9h is not necessarily be transparent as it is shielded from light by the black matrix. Therefore, the horizontal auxiliary capacitance line 9h may be formed of a thin metal film with low resistance, such as aluminum. The horizontal auxiliary capacitance line 9h has a shield function to reduce the coupling noise between the pixel electrodes 7, not only the function as auxiliary capacitance.

As for the liquid crystal cell 8 in which the data signals are already written, the potential of the pixel electrode 7 largely fluctuates only in one scan period by a potential fluctuation of the scan line Y of another row. If the scan line Y of another row becomes Vgon, the potential of the pixel electrode 7 shifts by +ΔV to the potential by the side of Vgon. After that, if the scan line Y of another row becomes Vgoff, the potential of the pixel electrode 7 shifts by −ΔV, then returns to the original potential.

When driving in the scan orders of the present invention, some liquid crystal cells 8 are influenced by the coupling noise from the scan line Y in the early stage after one to three scan periods after the data signals are written, while other liquid crystal cells 8 are influenced by the coupling noise from the scan line Y in the later stage after about one frame period after the data signals are written. As for the liquid crystal cells 8 that are influenced by the coupling noise from the scan line Y in the early stage, the response speed of the liquid crystal is reduced, thereby influencing the image quality. Thus it is preferable to form the configuration to reduce the coupling noise from the scan line Y.

Therefore, as illustrated in FIG. 13, it is preferable to form the cell auxiliary capacitance line 9c in the second layer on the line connecting the scan line Y and the pixel electrode 7 of the next row. Accordingly, the horizontal auxiliary capacitance line 9h and the cell auxiliary capacitance line 9c are formed in different layers. Further, the horizontal auxiliary capacitance line 9h and the cell auxiliary capacitance line 9c are connected via the through hole TH. The scan line Y with smaller parasitic capacitance can reduce the waveform rounding. Therefore, it is preferable to form the scan line Y and the cell auxiliary capacitance line 9c not to overlap with each other.

Further, the vertical auxiliary capacitance line 9v is formed in the same layer (second layer) as the data line X outside the display area of the liquid crystal display panel 2. Further, the vertical auxiliary capacitance line 9h and the vertical auxiliary capacitance line 9c are connected via the through hole TH.

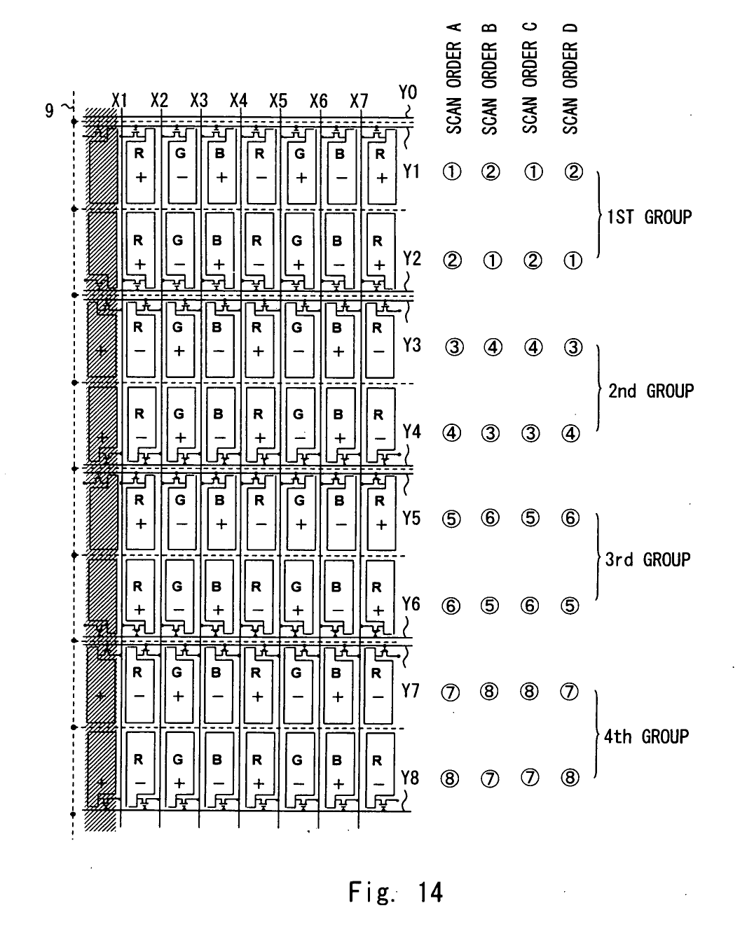

Next, another arrangement example of the liquid crystal cells 8 for reducing flicker is explained with reference to FIGS. 14 to 16. FIG. 14 is an arrangement example of liquid crystal cells in a display panel for explaining a driving method of a display panel according to the present invention.

In the example illustrated in FIG. 14, multiple liquid crystal cells 8 placed in the ith column (where i is an integer of zero or more, and i=0 is a dummy column) are alternately connected to the data line Xi and the data line Xi+1 by two rows (two scan lines). Note that the data line Xi and the data line Xi+1 are left and right adjacent. Specifically, the liquid crystal cells “1”, “2”, “5”, “6”, . . . , “1077”, and “1078” are connected to the data line X that is adjacent to the left side, and the liquid crystal cells “3”, “4”, “7”, and “8” . . . , “1079”, and “1080” are connected to the data line Xi+1 that is adjacent to the right side. Accordingly, in the display panel illustrated in FIG. 14, the liquid crystal cells 8 in one column are connected to different and adjacent data lines X alternately by two rows. The liquid crystal cells 8 are arranged in a zigzag pattern in the display panel. This arrangement is hereinafter referred to as two-step zigzag arrangement.

In order to reduce the coupling noise from the scan line Y, as illustrated in FIG. 1 or 14, two scan lines Y2k−2 and Y2k−1 are formed to be adjacent in parallel, and in a similar manner, two scan lines Y2k and Y2k+1 are formed to be adjacent in parallel. Two liquid crystal cells “2k−1” and “2k” of the same scan group are formed between scan lines Y2k−1 and Y2k. This configuration enables to increase the distance between the pixel electrode 7 of the liquid crystal cell “2k−1” and the scan line Y2k−2, and the distance between the pixel electrode 7 of the liquid crystal cell “2k” and the scan line Y2k+1, thereby reducing the coupling noise from the scan line Y.

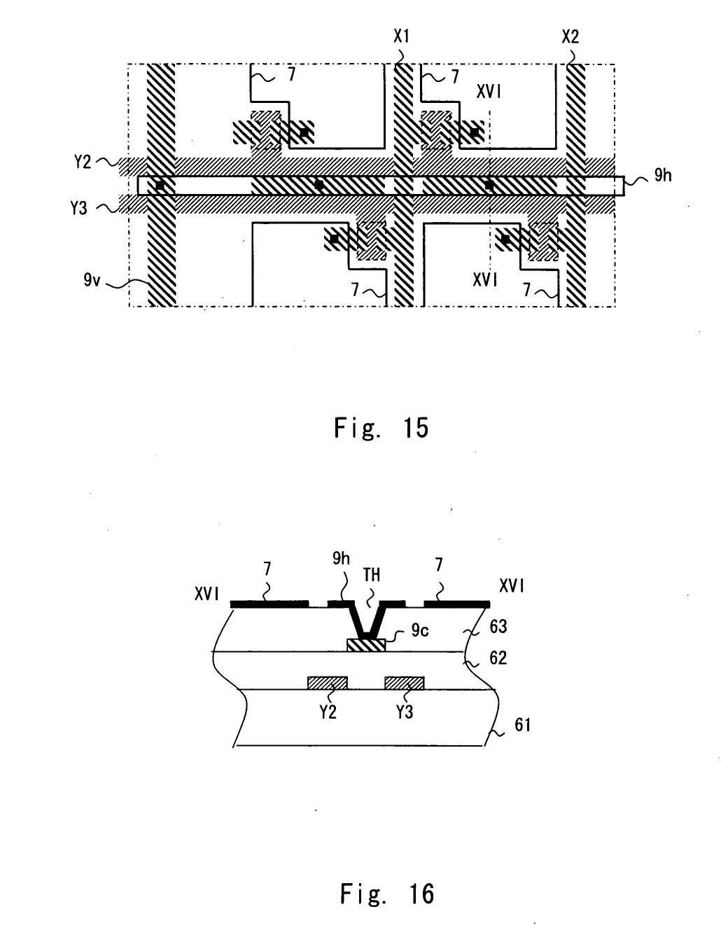

FIG. 15 is a plan view illustrating the configuration near the liquid crystal cells “2” and “3” of FIG. 14. FIG. 16 is a cross-sectional diagram taken along the line XVI-XVI of FIG. 15. As illustrated in FIG. 16, the cell auxiliary capacitance line 9c is formed between the scan lines Y2 and Y3 so that the cell auxiliary capacitance line 9c is not overlapped with the scan lines Y2 and Y3. This cell auxiliary capacitance line 9c has a small capacity and functions only as a shield.

As for auxiliary capacity, the cell auxiliary capacitance line 9c is formed between the liquid crystal cells “1” and “2” of the first scan group, and between the liquid crystal cells “3” and “4” of the second scan group to overlap with the pixel electrode 7.

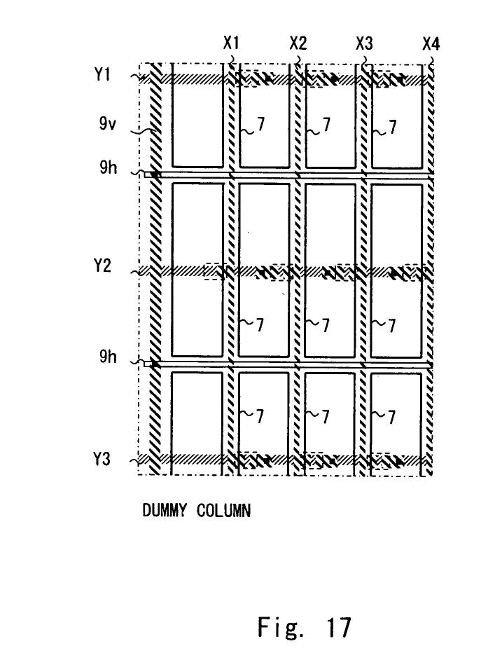

FIG. 17 illustrates another arrangement example of the liquid crystal cells 8 of the liquid crystal display panel 2. The horizontal auxiliary capacitance line 9h is formed between the pixel electrodes 7 in the same way as FIGS. 12 and 15. The difference is that the scan line Y is extended in the horizontal direction through almost the central part of the pixel electrode 7. Then the distance to the pixel electrode 7 of another row is increases, thereby enabling to suppress the influence of the coupling noise from the scan line Y.

In the In-Plain-Switching (IPS) liquid crystal display panel 2, the pixel electrode 7 and the common electrode are formed in the same layer in the shape of comb. Usually in the In-Plain-Switching liquid crystal display panel 2, the common electrode is formed between the pixel electrode 7 and the pixel electrode 7 of another row and functions as a shield, thus there is little influence of the coupling noise.

Further, in the liquid crystal display panel 2 of three RGB colors, the liquid crystal cells 8 are vertically long shape and the pixel electrode 7 is also vertically long comb-like shape, thus the parasitic capacitance with the scan line Y that extends in the horizontal direction is small, thus the coupling noise from the scan lines is also small. Therefore, the In-Plane-Switching liquid crystal display panel 2 does not necessarily have the configuration of FIGS. 12 and 13 or FIGS. 15 and 16, but may have other configuration as long as the pixel electrode 7 is not influenced by the coupling noise from the pixel electrode 7 of another row and the scan lines of another row.

The background that the column inversion driving, which has been considered to have low image quality, is adopted in recent years is because flicker and crosstalk are generated at the frame frequency of 60 Hz, thereby reducing the image quality. However in double-speed drive (120 Hz), the flicker and crosstalk, which are disadvantages of the column inversion driving, can be reduced. However, in the high definition liquid crystal display panel of amorphous TFT, the on resistance of TFT is high, and if the frame frequency is made higher than 120 Hz such as quad-speed drive (240 Hz), the data signals are not sufficiently written to the pixel electrode 7.

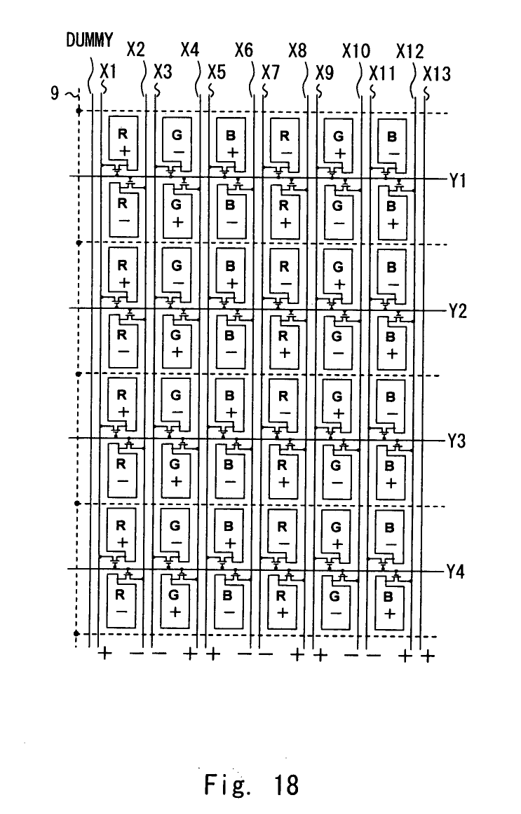

FIG. 18 is an arrangement example of the liquid crystal cells 8, in which the total number of data line is doubled, the total number of scan lines is reduced by half, and the driving period is doubled in order to improve the insufficient writing to the pixel electrode 7 that achieves pseudo 1H dot inversion display. In the color liquid crystal panel with full HD pixels, the total number of data lines is 11520 and the total number of scan line is 540.

Odd numbered data lines X2i−1 and even numbered data lines X2 are provided to the left and right of each liquid crystal cell 8 in the ith column, where i is a natural number. The liquid crystal cells 8 in the odd numbered rows are connected to the left side odd numbered data lines X2−i, whereas the liquid crystal cells in the even numbered lines are connected to the right side even numbered data rows X2i. One scan line Yj is shared by the liquid crystal cells 8 of 2j−1 th row and the liquid crystal cells 8 in 2jth row, where j is a natural number.

In this arrangement, the gap between the data line X2i and the data line X2i+1 becomes narrow, thereby increasing the parasitic capacitance value. When data signals with opposite polarities from each other are respectively supplied to the two data lines X2i and X2i+1, the driving current of the data signals becomes increases. Therefore, data signals with the same polarity are supplied to the data lines X2i and X2i+1 with narrow gap therebetween.

As illustrated in FIG. 18, data signals of “+, −, −, +” are supplied to the data lines X1, X2, X3, and X4 in a certain frame period, and in the next frame period, the polarities of the data signals are reversed to supply the data signals of “−, +, +, −”. The data signals similar to the data lines X1 to X4 are supplied to the data lines after data line X4. By driving the data lines in this way, pseudo 1H dot inversion display can be achieved. In order to equalize the parasitic capacitance value of the data line X1 with the parasitic capacitance value of another data line, a dummy data line is formed to the left side of the data line X1. Although not illustrated, a dummy data line is formed also to the right side of the data line X11520.

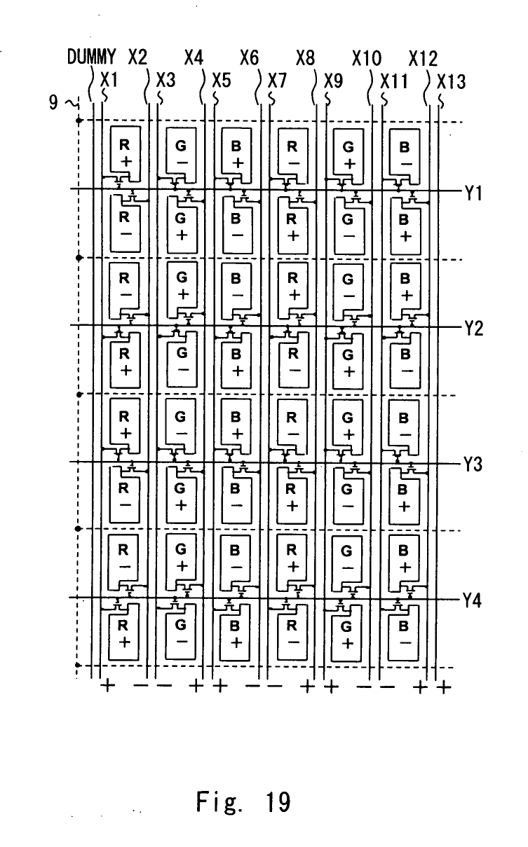

FIG. 19 illustrates another arrangement example of the liquid crystal cells 8. FIG. 19 illustrates an arrangement example in which the total number of data lines is doubled, the total number of scan lines is reduced by half, and the driving period is doubled to achieve pseudo 2H dot inversion display. One scan line is shared by two adjacent rows in a similar way as FIG. 18. The different point is that the liquid crystal cells 8 in the first and fourth rows are connected to the odd numbered data lines on the left side, and the liquid crystal cells 8 in the second and third rows are connected to the even numbered data lines on the right side. The liquid crystal cells 8 after the fourth rows are connected in a similar manner as the liquid crystal cells 8 in the first to fourth columns.

As illustrated in FIG. 19, the data signals of “+, −, −, +” are supplied to the data lines X1 to X4, and in the next frame period, the polarities of the data signals are reversed to supply the data signals of “−, +, +, −”. The same polarity data signals similar to the data lines X1 to X4 are supplied to the data lines after data line X4. By driving in this way, pseudo 2H dot inversion display can be achieved. Although not illustrated, if the liquid crystal cells 8 of the first and second rows are connected to the odd numbered data lines, and the liquid crystal cells 8 of the third and fourth rows are connected to the even numbered data lines, 2H dot inversion display other than the one illustrated in FIG. 19 can be realized.

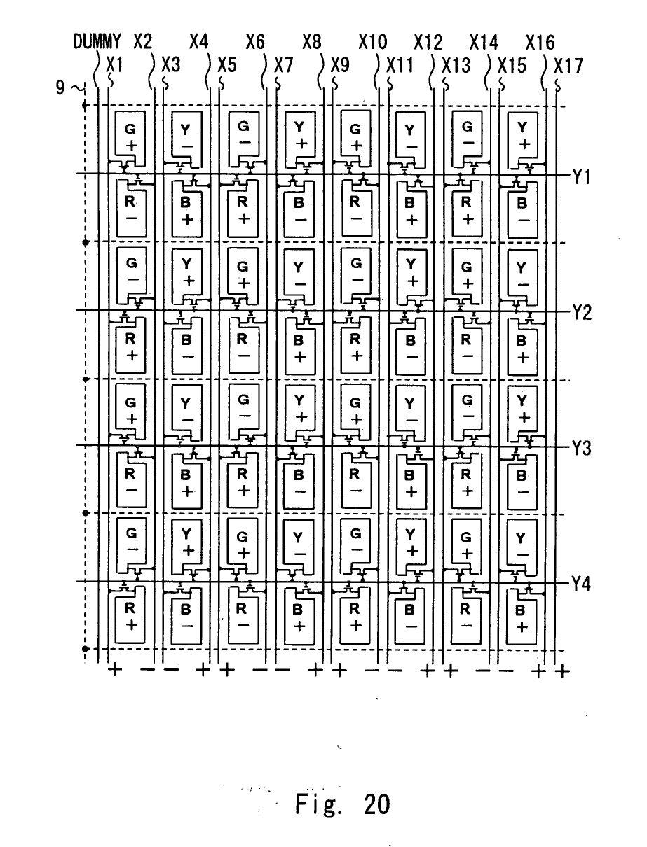

FIG. 20 illustrates another arrangement example of the liquid crystal cells 8. FIG. 20 illustrates an arrangement in which the color filters are four colors and one pixel is composed of four liquid crystal cells of two×two. In the full HD color liquid crystal panel, the total number of data lines is 1920×4=7680, and the total number of scan lines is 1080. One scan line Yj is shared by the liquid crystal cells 8 of 2j−1 th row and the liquid crystal cells 8 of 2jth row, where j is a natural number.

Next, the connection between each liquid crystal cell 8 and the data line X is explained. The first and second columns are explained first. In the first and second columns, the liquid crystal cells 8 of the first and fourth rows are respectively connected to the left side odd numbered data lines X1 and X3, whereas the liquid crystal cells 8 of the second and third row are respectively connected to the right side even numbered data lines X2 and X4. The liquid crystal cells 8 after the fourth row are connected in a similar manner as the liquid crystal cells 8 of the first to fourth rows.

The third and fourth columns are explained next. In the third and fourth columns, the liquid crystal cells 8 of the first and fourth rows are respectively connected to the even numbered data lines X6 and X8, whereas the liquid crystal cells 8 of the second and third rows are respectively connected to the left side odd numbered data lines X5 and X7. The liquid crystal cells 8 after the fourth row are connected in a similar manner as the liquid crystal cells 8 of the first to fourth rows. The connections after the fourth column are connected in a similar manner as the connections of the first to fourth columns.

The data signals of “+, −, −, +” are supplied to the data lines X1, X2, X3, and X4. The data signals are supplied to the data line X5 and subsequent data lines in a similar manner as the data lines X1 to X4. By driving in this way, pseudo 2H dot inversion display can be achieved. However when looking at only one color, it is practically 1H dot inversion display.

In order to add yellow (Y) in the four color arrangement of two×two, blue and yellow liquid crystal cells 8 are arranged in the same column, as yellow is complementary color of blue. Further, red and green liquid crystal cells 8 are placed in the same column. If red and green color purity is thickened, golden color or the like can faithfully be displayed.

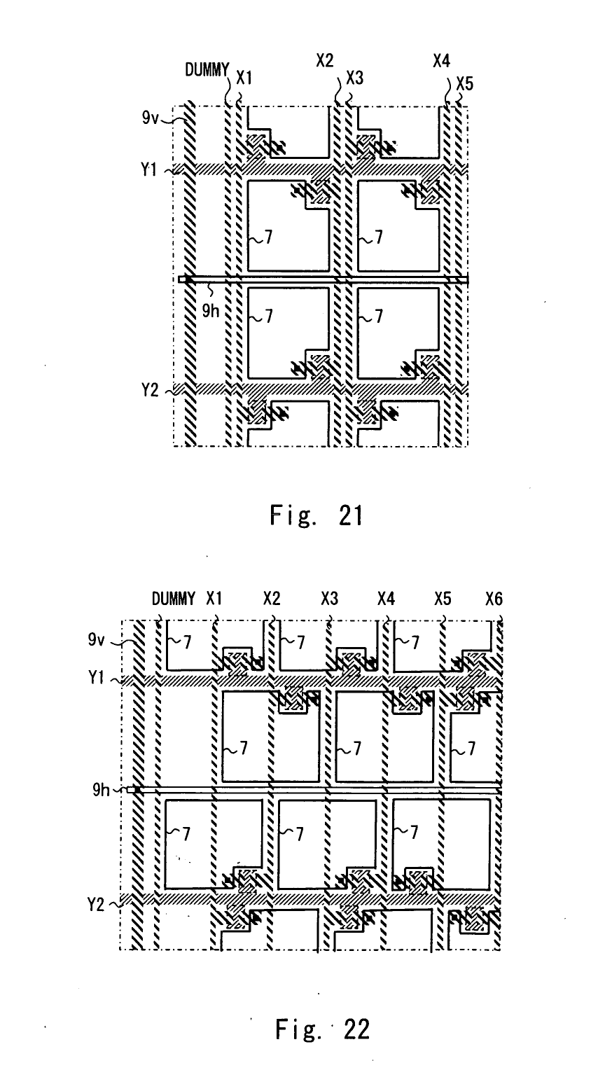

FIG. 21 illustrates a layout of the liquid crystal display panel 2 illustrated in FIGS. 18, 19, and 20. In case of the arrangement in which two rows share one scan line Y, the pixel electrode 7 connected to the scan line Yj is away from the scan lines Yj−1 and Yj+1 by one cell pitch (for the vertical width of the liquid crystal cell 8), thus the pixel electrode 7 is not influenced by the coupling noise from the scan line Y.

The liquid crystal cells 8 of the 2j−1 th row and the 2jth row, which are connected to the scan line Yj, are selected at the same time, thus the pixel electrode 7 of the 2j−1th row and the pixel electrode 7 of the 2jth row are not influenced by the coupling noise of each other. Therefore, the horizontal auxiliary capacitance line 9h on the scan line Y is unnecessary. As described so far, by removing the unnecessary horizontal auxiliary capacitance line 9h, it is possible to reduce the parasitic capacitance between the data line X and the horizontal auxiliary capacitance line 9h. Note that the horizontal auxiliary capacitance line 9h between the pixel electrode 7 of the 2jth row and the pixel electrode 7 of the 2j+1 th row for shielding the coupling noise is necessary.

In the liquid crystal display panel 2 illustrated in FIGS. 18, 19, and 20, the narrower the gap between the data lines, the larger the parasitic capacitance of the data line X, thereby increasing the driving current of the data signals. As a countermeasure against that, FIG. 22 illustrates an example of forming the data lines X to be straight lines at regular intervals in the vertical direction. As illustrated in FIG. 22, the liquid crystal cells 8 in even numbered columns are placed by shifting ½ cell pitch (half of the horizontal width of the liquid crystal cell) against the liquid crystal cells 8 in odd numbered rows.

In the example illustrated in FIG. 22, the liquid crystal cells 8 of even numbered rows are shifted to right by ½ cell pitch from the odd numbered rows. Although not illustrated, the liquid crystal cells 8 of even numbered rows are shifted to left by ½ cell pitch from the odd numbered rows. Especially in the arrangement of FIG. 20, which is four colors of two×two, the same color liquid crystal cells 8 are aligned on a straight line, thus the straight line will not be zigzag when displaying diagrams and tables by single color.

The reason to shift by ½ each is explained hereinafter. If the liquid crystal cells 8 are not shifted by ½ cell pitch, the odd data lines X2i−1 are formed to the side surface part of the liquid crystal cells 8, and the even data lines X2i are formed to the central part of the liquid crystal cells 8. Therefore, the parasitic capacitance value differs between the odd numbered data lines X2i−1 and the even numbered data lines X2i. As a result, the waveforms of the data signals differ, thereby deteriorating the image quality.

By shifting the liquid crystal cells 8 by ½ cell pitch, the odd numbered data lines X2i−1 are formed to almost central part of the liquid crystal cell 8 in the odd numbered rows, whereas in the even numbered rows, the even numbered data lines X2i−1 are formed to the side surface part of the liquid crystal cell 8. On the other hand, the even numbered data lines X2i are formed to the side surface part of the liquid crystal cells 8 in the odd numbered rows, whereas in the even numbered rows, the even numbered data lines X2i are formed to the central part of the liquid crystal cells 8. Therefore, the number of the liquid crystal cells including the data lines X formed to the central part thereof, and the number of liquid crystal cells including the data lines X formed to the side surface part thereof are equal. Thus the parasitic capacitance value of the odd numbered data line X2i−1 and that of the even numbered data line X2i can be the same.

As with the layout illustrated in FIG. 22, if the data lines X are placed with equal distance therebetween, the polarities of the adjacent data lines X may be different. That is, the data signals of “+, −, +, −” may be supplied to the data lines X1-X4, and the polarities are reversed in the next frame period to supply the data signals of “−, +, −, +”.

In any arrangement of the FIGS. 18, 19, and 20, by driving in the scan orders explained in the first to fifth exemplary embodiments, the average driving current of the data signals can be ¾ or less of the reference current value in all the display patterns.

### Sixth Exemplary Embodiment

This exemplary embodiment explains the setting procedure of the scan orders for four continuous scan lines as one scan group. In the following explanation, the “second” is a scan line selected second in the first scan order, the “third” is a scan line selected as third in the first scan order, and the “fourth” is a scan line selected fourth in the first scan order.

a. Any one scan order shall be the first scan order.
e. The second scan order is the order of “second”, “fourth”, “first”, and “third” orders in the first scan order.
f. The third scan order is the order of “fourth”, “third”, “second”, and “first” order of the first scan order.
g. The fourth scan order is the order of “third”, the “first”, “fourth”, and “second” of the first scan order.

For example, the first scan order is the order of scan lines Y1→Y4→Y2→Y3, the second scan order is the order of scan lines Y4→Y3→Y1→Y2, the third scan order is the order of scan lines Y3→Y2→Y4→Y1, and the fourth scan order is the order of scan line Y2→Y1→Y3→Y4. In this example as well, the driving current of data signals when displaying the first maximum current pattern (the display pattern 9 in this example) in the second and fourth scan orders is ½ of the reference current value. The driving current of data signals when displaying the second maximum current pattern (the display pattern 2 in this example) in the first and third scan orders is ½ of the reference current value.

The setting procedure common to the first to sixth exemplary embodiments is explained here. If the first scan order is any one of the scan orders, the scan order in which the driving current of the data signals becomes ½ when displaying the first maximum current pattern is specified as the second scan order. The first maximum current pattern is the display pattern in which the number of charge and discharge becomes the maximum number in the first scan order. The maximum current pattern of the third scan order is the same as the first maximum current pattern, however the scan order is specified to a different scan order from the first scan order. In the fourth scan order, the driving current of the data signals become ½ when displaying the first maximum current pattern, however the scan order is specified to a different scan order from the second scan order.

Therefore, the driving current in the second and fourth scan orders become ½ of the reference current value when displaying the first maximum current pattern. Further, the driving current in the first and third scan orders become ½ of the reference current value when displaying the second maximum current pattern in which the number of charge and discharge become maximum in the second scan order.

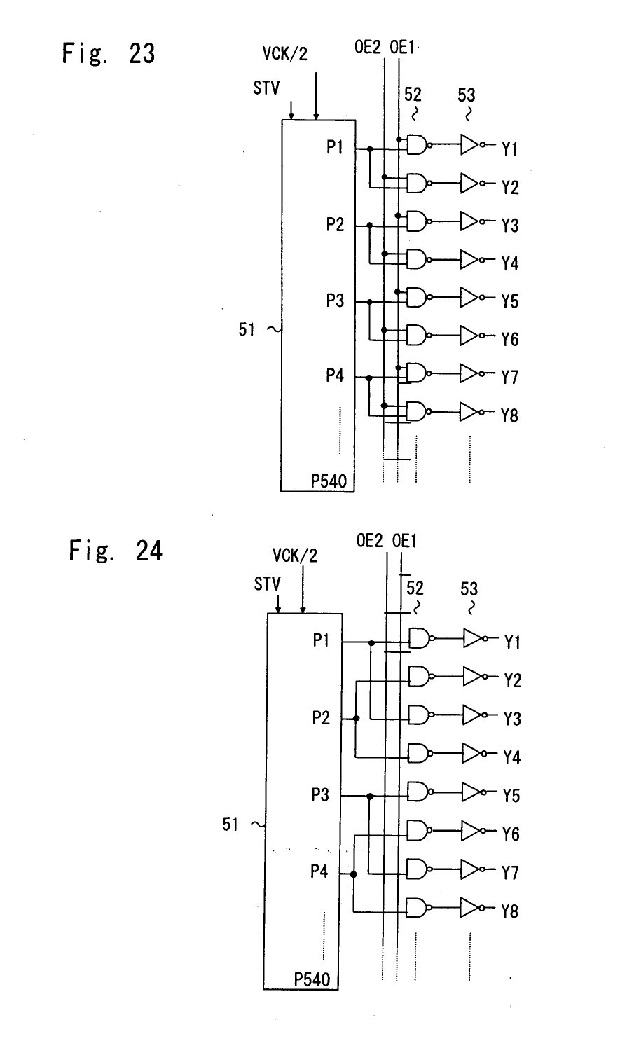

Next, the gate driver 4 used by the present invention is explained. The gate driver 4 is controlled by multiple enable signals. In order to realize multiple scan orders explained in the first to fourth exemplary embodiments, the gate driver 4 illustrated in FIG. 23 is used. As illustrated in FIG. 23, the gate driver 4 is provided with a shift register 51, NAND circuits 52, and output buffers 53. The gate driver 4 of FIG. 23 is controlled by two enable signals OE1 and OE2.

The enable signal OE1 is input to the NAND circuits 52 that corresponds to the odd numbered scan lines. The enable signal OE2 is input to the NAND circuits 52 that correspond to the even numbered scan lines. Further, internal signals P output from the shift register 51 are respectively input to the two NAND circuits 52 that correspond to the scan lines of the same scan group.

The shift register 51 operates by a clock signal VCK/2 having ½ frequency of a vertical clock signal VCK. In the gate driver 4 of FIG. 23, an NAND circuit with two inputs can be used, thereby enabling to reduce the circuit size as compared to the decoder circuit configuration.

The circuit illustrated in FIG. 24 realizes the scan order explained in the fifth exemplary embodiment. The gate driver 4 of FIG. 24 is controlled by the two enable signal OE1 and OE2. The internal signals P output from the shift register 51 is respectively input to the two NAND circuits 52 of the same scan group.

However, in the fifth exemplary embodiment, the scan lines Y1 and Y3 are the first scan group, and the scan lines Y2 and Y4 are the second scan group. Therefore, the internal signal P1 is input to the NAND circuit 52 that corresponds to the scan lines Y1 and Y3. The internal signal P2 is input to the NAND circuit 52 that corresponds to the scan lines Y2 and Y4. Further, the enable signal OE1 is input to the NAND circuit 52 that corresponds to the scan lines Y1 and Y2. The enable signal OE2 is input to the NAND circuit 52 that corresponds to the scan lines Y3 and Y4. The circuits corresponding to the subsequent scan lines following the scan line Y4 may be configured in a similar manner as the circuits corresponding to the scan lines Y1 to Y4.

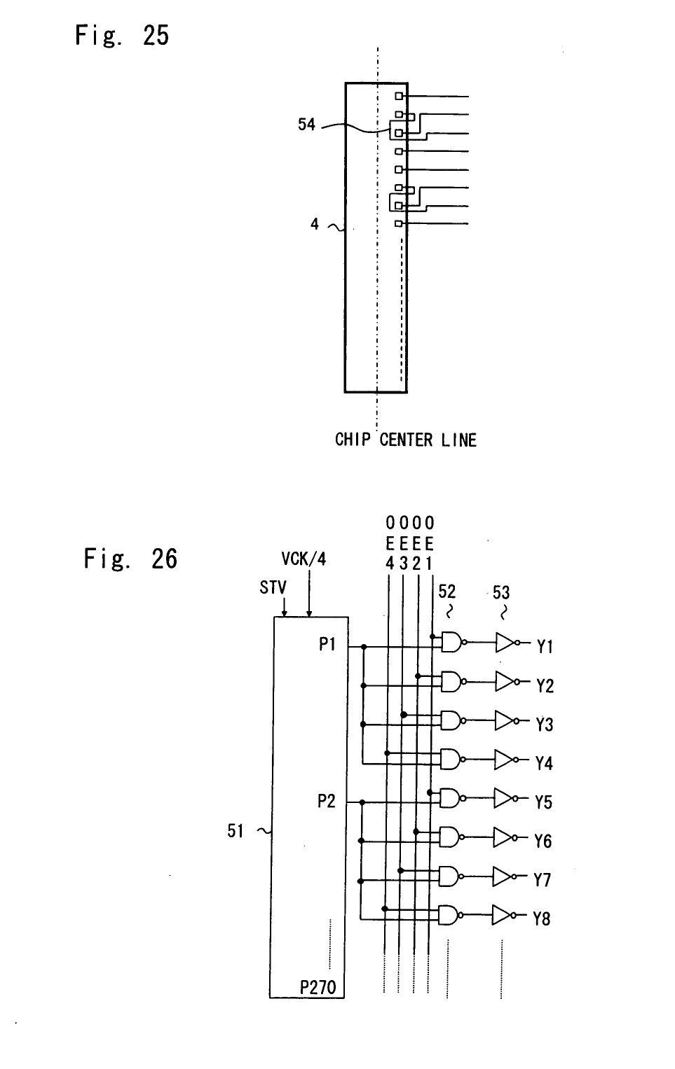

As illustrated in FIG. 25, a line 54 over COF (Chip on Film) or the liquid crystal display panel 2 is pulled out in the direction of the chip center line from the output pad corresponding to the scan line Y4k−2, and the output pad corresponding to the adjacent scan line Y4k−1 is bypassed to change the connected destination. Then, the scan order of the fifth exemplary embodiment can be realized by the gate driver 4 illustrated in FIG. 23. Needless to say, in a similar manner, the scan orders of the first to fourth exemplary embodiments can be realized by the gate driver illustrated in FIG. 24.

In order to respond to all the scan orders explained in the first to sixth exemplary embodiments, four enable signals OE1, OE2, OE3, and OE4 can be used to control the gate driver as illustrated in FIG. 26. The enable signal OE1 is input to the NAND circuits 52 corresponding to the scan lines Y1, Y5, Y9, . . . , and Y1077. The enable signal OE2 is input to the NAND circuits 52 corresponding to the scan lines Y2, Y6, Y10, . . . , and Y1078. The enable signal OE3 is input to the NAND circuits 52 corresponding to the scan lines Y3, Y7, Y11, . . . , and Y1079. The enable signal OE4 is input to the NAND circuits 52 corresponding to the scan lines Y4, Y8, Y12, . . . , and Y1080. The shift register 51 operates by a clock signal VCK/4 having ¼ frequency of the vertical clock signal VCK.

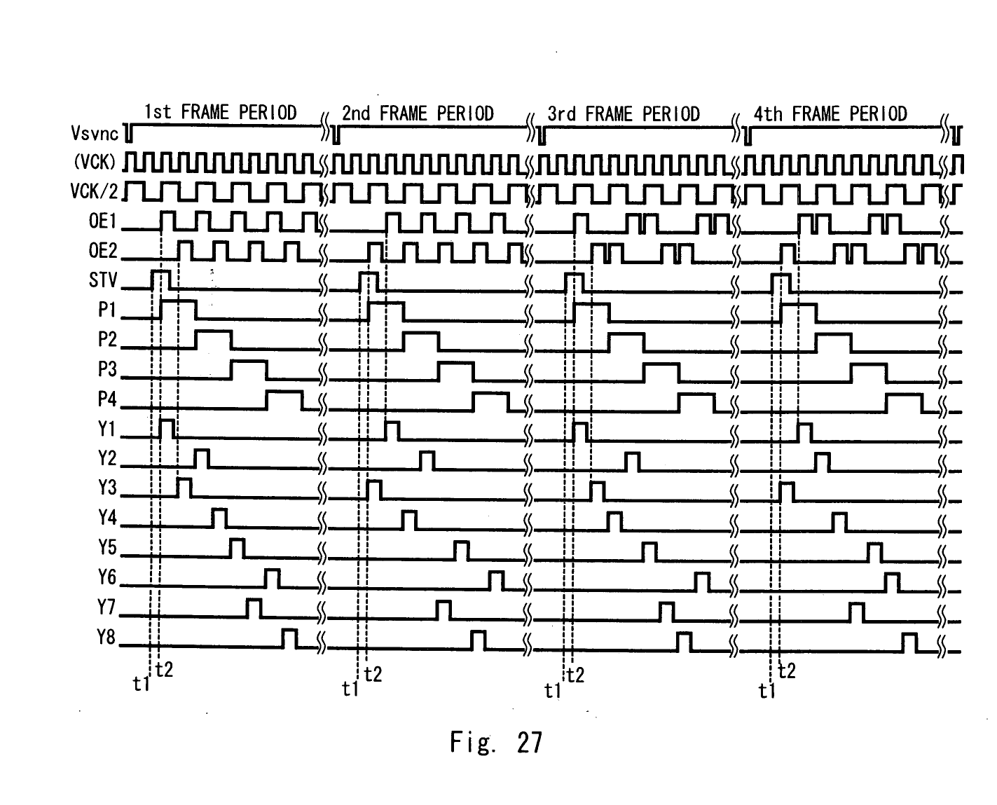

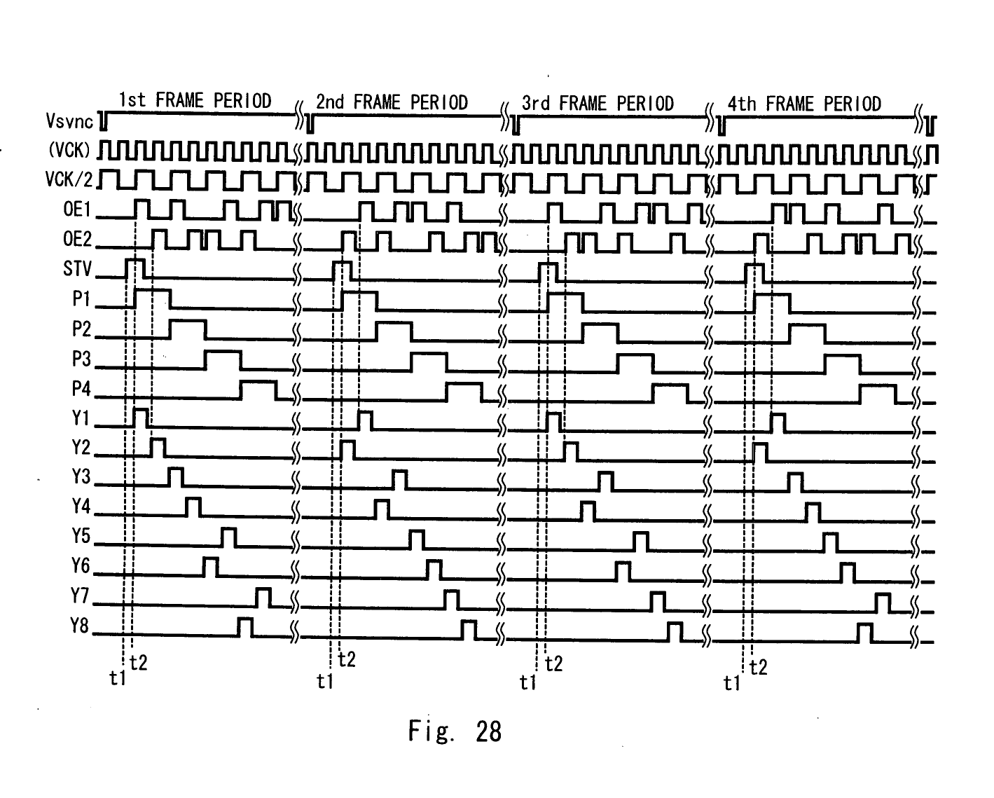

An example of realizing the driving method of a display panel according to the first and second exemplary embodiments using the gate driver of FIG. 23 is explained hereinafter with reference to FIGS. 27 and 28. FIG. 27 is a timing chart for realizing the driving method of the display panel according to the first exemplary embodiment using the gate driver 4 illustrated in FIG. 23 in case the number of the enable signals is two. FIG. 28 is a timing chart for realizing the driving method of the display panel according to the second exemplary embodiment using the gate driver 4 illustrated in FIG. 23 in case the number of the enable signals is two.

At the time t1 in each frame period, the vertical start signal STV is activated, and the internal signals P are synchronized with a rising edge of the clock signal VCK/2 to be sequentially output. The internal signals P are activated in order of P1→P2→P3→P4→ . . . →P540, each having activated period for two scan periods. Note that the number n of the enable signals OE1 and OE2 illustrated in FIG. 27 indicates the nth scan period. That is, 1 indicates to activate in the first scan period.

When the first enable signal is activated at the time t2, the first scan period starts. For example, if the first frame period of FIG. 28 is the scan order E, the enable signal OE1 may be activated in the first, third, sixth, and eighth scan periods, and the enable signal OE2 may be activated in the second, fourth, fifth, and seventh scan periods. The other enable signals in the second to fourth frame periods may be activated in the periods illustrated in the drawing, thus the explanation is omitted.

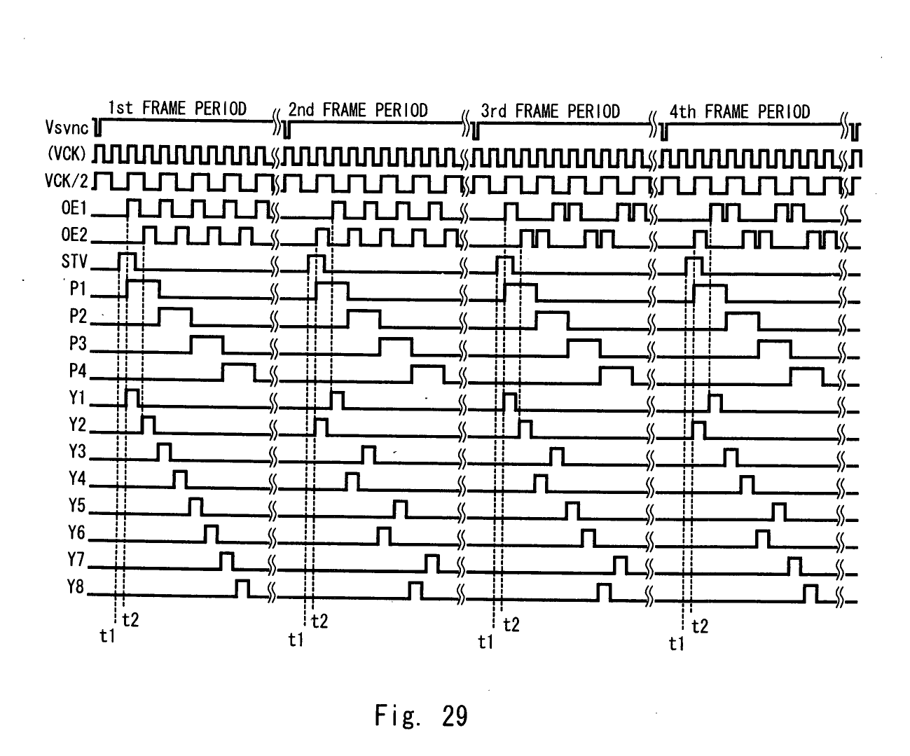

Next, an example of realizing the driving method of the display panel according to the fifth exemplary embodiment using the gate driver 4 of FIG. 24 is explained with reference to FIG. 29. FIG. 29 is a timing chart for realizing the driving method of the display panel according to the fifth exemplary embodiment using the gate driver 4 illustrated in FIG. 24 in case the number of enable signals is two.

At the time t 1 in each frame period, the vertical start signal STV is activated, and the internal signals P are synchronized with a rising edge of the clock signal VCK/2 to be sequentially output. The internal signals P are activated in order of P1→P2→P3→P4→ . . . →P540, each having activated period for two scan periods.

When the first enable signal is activated at the time t2, the first scan period starts. As for the first frame period in the scan order A′, The enable signal OE1 may be activated in the first, third, fifth, and seventh scan periods, and the enable signal OE2 may be activated in the second, fourth, sixth, and eighth scan periods. The other enable signals in the second to fourth frame periods may be activated in the periods illustrated in the drawing, thus the explanation is omitted.

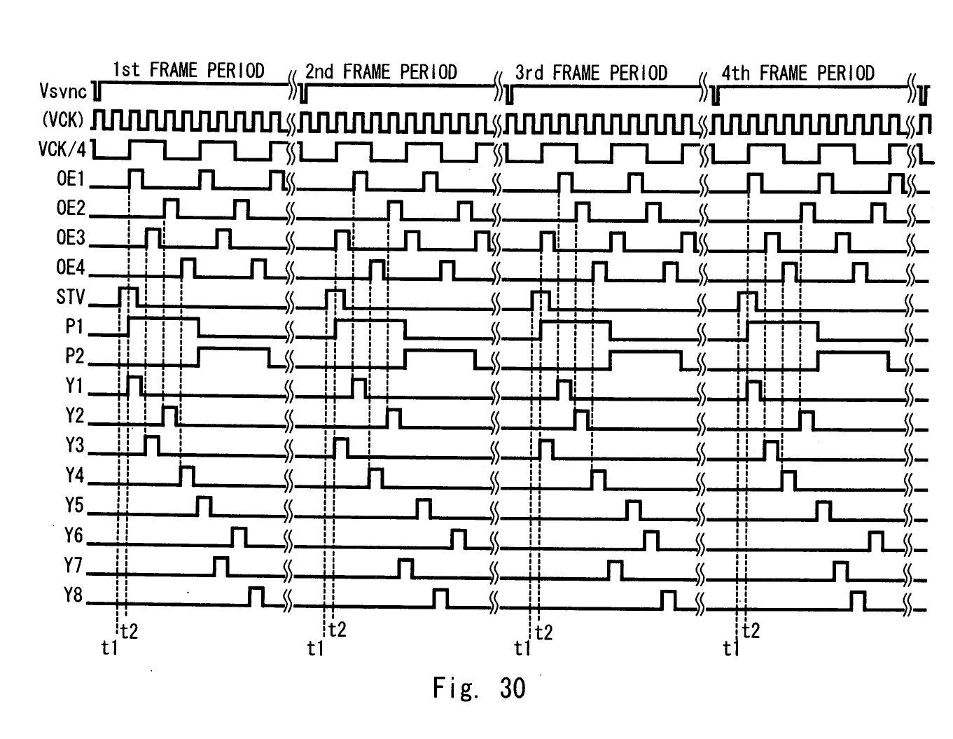

Next, an example of realizing the driving method of the display panel according to the fifth exemplary embodiment using the gate driver 4 of FIG. 26 is explained with reference to FIG. 30. FIG. 30 is a timing chart for realizing the driving method of the display panel according to the fifth exemplary embodiment using the gate driver 4 illustrated in FIG. 26 in case the number of enable signals is four.

At the time t1 in each frame period, the vertical start signal STV is activated, and the internal signals P are synchronized with a rising edge of the clock signal VCK/4 to be sequentially output. The internal signals P are activated in order of P1→P2→P3→P4→ . . . →P270, each having activated period for four scan periods.

When the first enable signal is activated at the time t2, the first scan period starts. As for the first frame period in the scan order A′, the enable signal OE1 is activated only in the first and fifth scan periods, the enable signal OE2 is activated only in the third and seventh scan periods, the enable signal OE3 is activated only in the second and sixth scan periods, and the enable signal OE4 is activated only in the fourth and eighth scan periods. The other enable signals in the second to fourth frame periods may be activated in the periods illustrated in the drawing, thus the explanation is omitted.

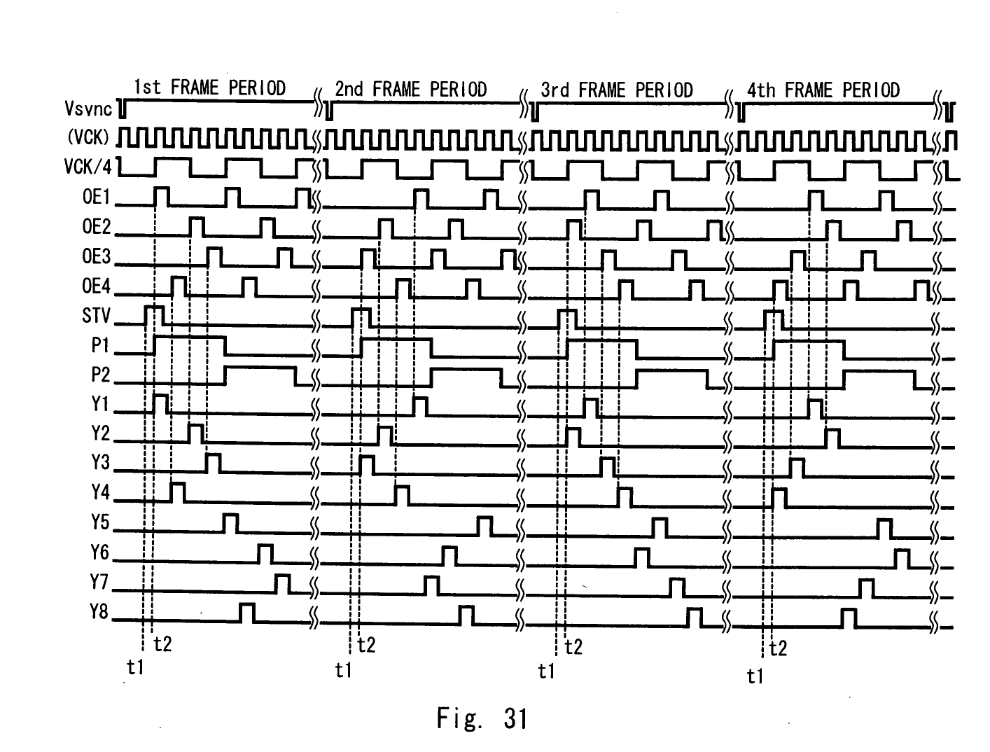

Next, an example of realizing the driving method of the display panel according to the sixth exemplary embodiment using the gate driver 4 of FIG. 26 is explained with reference to FIG. 31. FIG. 31 is a timing chart for realizing the driving method of the display panel according to the sixth exemplary embodiment using the gate driver 4 illustrated in FIG. 26 in case the number of enable signals is four.

At the time t1 in each frame period, the vertical start signal STV is activated, and the internal signals P are synchronized with a rising edge of the clock signal VCK/4 to be sequentially output. The internal signals P are activated in order of P1→P2→P3→P4→ . . . →P270, each having activated period for four scan periods.

When the first enable signal is activated at the time t2, the first scan period starts. In the first frame period, the enable signal OE1 is activated in the first and fifth scan periods, the enable signal OE2 is activated in the third and seventh scan periods, the enable signal OE3 is activated in the fourth and eighth scan periods, and the enable signal OE4 is activated the second and sixth scan periods. The other enable signals in the second to fourth frame periods may be activated in the periods illustrated in the drawing, thus the explanation is omitted.

The timing controller 5 outputs multiple enable signals to the gate driver 4 for controlling the scan order. In order to respond to each scan order, the image data to be supplied to the data driver 3 is replaced as well. If the image data is replaced by the timing controller 5, a commercial data driver can be used. The timing controller 5 controls the data driver 3 and the gate driver 4 in consideration that the commercial data driver has two latches, which are a sample latch for one scan period and a hold latch for one scan period.

In the first to fourth exemplary embodiments, the image data may be replaced inside the data driver 3. In this case, a sampling latch for two scan periods, a hold latch for two scan periods, and a multiplexer in the next stage are provided to the data driver 3. The image data for two scan periods can be latched to the sampling latch and transferred collectively to the hold latch by every two scan periods so as to replace the image data by the multiplexer. However in the fifth and sixth exemplary embodiments, a latch circuit for four scan periods is required, thereby causing to increase the circuit size, thus the time controller 5 should be used to replace the image data.

The number of scan lines composing one scan group is preferably two in consideration of the circuit size of the gate driver and the timing controller.

As mentioned above, in the present invention, by switching at least two or more scan orders having different maximum current patterns by a predetermined period, the average driving current of a particular display pattern can be reduced, and the average driving current of the data signals can be ¾ or less of the reference current value in all the display patterns. As a result, the highest attainable temperature of the data driver 3 can be reduced. Moreover, the influence of a previous data signal is dispersed temporally and spatially to improve the image quality.

Note that the exemplary advantage of current reduction cannot be achieved if the present invention is applied to a driving method in which voltage polarities of data signals are reversed by one or two scan periods (1 or 2H), as the reversal of voltage polarities is prioritized over current reduction. The exemplary advantage of current reduction is achieved if the voltage polarity reverse cycle of a data signal is more than two scan periods. For example, when the voltage polarity of the data signal is reversed every four scan periods, the maximum value of the average driving current of the data signals is ⅞ of the reference current value. The column inversion driving in which the data signals are reversed every frame period reduces the maximum value of the average driving current most.

The present invention is not limited to the above exemplary embodiments, but may be modified as appropriate within the sprit and the scope of the present invention. The present invention explained examples in which the liquid crystal panel is normally black, but it may be normally white. Further, the present invention can be applied to an organic electroluminescence display panel etc. In an organic electroluminescence display panel, the voltage polarity of a data signal is usually constant, and does not reverse as in liquid crystals.

The first to sixth exemplary embodiments can be combined as desirable by one of ordinary skill in the art.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A method of driving a display panel in which a voltage polarity reverse cycle of a data signal is three or more scan periods, and a plurality of scan lines are driven by switching between a first and a second scan orders by a predetermined period, the method comprising:
setting a display pattern as a first maximum current pattern, the display pattern in which the plurality of scan lines are driven in the first scan order and a number of charge and discharge of the data signal becomes a maximum number; and
specifying that the number of charge and discharge of the data signal in case of displaying the first maximum current pattern in the second scan order is to be ½ of the number of charge and discharge of the data signal in case of displaying the first maximum current pattern in the first scan order,
wherein the voltage polarity reverse cycle for specifying the first and the second scan orders is one frame period.

2. The method according to claim 1, further comprising:
setting a display pattern as a second maximum current pattern, the display pattern in which the plurality of scan lines are driven in the second scan order and a number of charge and discharge of the data signal becomes a maximum number; and
specifying that the number of charge and discharge of the data signal in case of displaying the second maximum current pattern in the first scan order is to be ½ of the number of charge and discharge of the data signal in case of displaying the second maximum current pattern in the second scan order.

3. The method according to claim 1, wherein
two or more scan lines including a 2k−1th and a 2kth (k is a natural number) scan lines are grouped into a kth scan group, and
the second scan order is specified to be a scan order obtained by reversing scan orders in each odd numbered group of the first scan order.

4. The method according to claim 3, further comprising:
specifying a scan order obtained by reversing a scan order in each scan group in the first scan order as a third scan order;
specifying a scan order obtained by reversing a scan order in each scan group in the second scan order as a fourth scan order,
wherein the plurality of scan lines are switched in the first to the fourth scan orders to drive by a predetermined period.

5. The method according to claim 3, wherein no scan line other than the kth scan group is formed between the 2k−1th scan line and the 2kth scan line.

6. The method according to claim 3, wherein at least one or more scan line other than the kth scan group is formed between the 2k−1th scan line and the 2k scan line.

7. A gate driver that drives the plurality of scan lines in the scan order according to claim 1.

8. The gate driver according to claim 7, wherein the gate driver is controlled by two or more enable signals.

9. A display apparatus comprising a display panel that is driven by the method according to claim 1.

10. The display apparatus according to claim 9, wherein the display panel comprises:
a first display cell that is connected to a first data line and a first scan line;
a second display cell that is connected to the first data line and a second scan line;
a third display cell that is connected to a second data line and a third scan line, the second data line being adjacent to the first data line; and
a fourth display cell that is connected to the second data line and a fourth, scan line, wherein
the first, the second, the third, and the fourth display cells are placed in a same column, and
a data signal of a first voltage polarity is supplied to the first and the second display cells, and a data signal of a second voltage polarity is supplied to the third and the fourth display cells, the second voltage polarity being different from the first voltage polarity.

11. The display apparatus according to claim 10, wherein the third and the fourth display cells are placed between the first and the second display cells.
